(19) United States
(12) Patent Application Publication
(10) Pub. No.: US 2024/0291925 A1
(43) Pub. Date: Aug. 29, 2024

(54) SYSTEM AND METHOD FOR CUSTOMIZED PRINTING

(71) Applicant: Kenneth F. Flower, Fremont, OH (US)

(72) Inventor: Kenneth F. Flower, Fremont, OH (US)

(21) Appl. No.: 18/590,481

(22) Filed: Feb. 28, 2024

Related U.S. Application Data
(60) Provisional application No. 63/487,376, filed on Feb. 28, 2023.

(51) Int. Cl. H04N 1/00; G06T 7/00; H04N 1/387

(52) U.S. Cl. CPC H04N 1/00676; G06T 7/001; H04N 1/0044; H04N 1/3875; G06T 2207/30144

(57) ABSTRACT

A system for printing and cutting shapes on a product is provided. The customized printing system may include a communication module that receives an image and an identified parameter for the product. The system may also include an apportionment module that determines a die-line file and an image file to be printed on the product, with a real-time preview displayed by the communication module, via a user interface. The die-line file and image file may be transmitted to a production module, which can be in communication with a printer and a cutter. The printer may print the image on the product, while the cutter cuts the shape out of the product based on the die-line file. This system enables efficient and accurate production of printed products with customized images and shapes using artificial intelligence and/or machine learning. A method of printing an image on a product is also provided.

### CROSS-REFERENCE TO RELATED APPLICATIONS

This application claims the benefit of U.S. Provisional Application No. 63/487,376 filed on Feb. 28, 2023. The entire disclosure of the above application is incorporated herein by reference.

### FIELD

The present technology relates to systems and methods for customized printing and, more particularly, systems and methods for printing an image on a product to be manufactured with the image.

### INTRODUCTION

This section provides background information related to the present disclosure which is not necessarily prior art.

In general, known systems for making custom printed and cut products such as vehicle air fresheners often restrict the shape and/or size of the printed product to templates. These templates often fix at least one of the shape and size of the printed product, typically for simplicity or cost efficiency of the printed product maker.

Where vehicle air fresheners are being manufactured as printed products, it is known to provide a preset template, which can be a 4 inch by 2 inch rectangle, for example. Although some systems can permit the selected template to be changed, such changes to the template are typically created manually by individual cropping of images. This is time consuming, inefficient, and frustrating for users who are often not able to proof their designs before placing an order. In addition, the use of templates in any form, even if a large number of templates is available, inherently limits the shape and/or size of the printed product.

Additionally, conventional systems for printing images on products and cutting shapes out of products such as vehicle air fresheners have involved separate and disconnected processes. Typically, the image to be printed on the product, and the shape to be cut out of the product, have been handled independently. This normally requires multiple steps and the use of different pieces of equipment at each of the steps. Such conventional systems and methods have resulted in inefficiencies, increased production time, and potential misalignment between the printed image and the cut shape. Additionally, it becomes difficult to ensure precise alignment between the printed image and the cut shape, leading to inconsistencies in the final product. Further, any adjustments or modifications to the image or shape required separate actions, leading to potential errors and delays.

Accordingly, there is a continuing need for an improved system and method for making custom printed products. Desirably, the improved system and method allow for greater customization of printed products while minimizing errors in the process.

### SUMMARY

In concordance with the instant disclosure, improved systems and methods for making custom printed products, and which allow for greater customization of the printed products while minimizing errors, have surprisingly been discovered.

The present technology includes articles of manufacture, systems, and processes that relate to the creation of customized printed products, wherein such products are manufactured with images and shapes specified by a user, and wherein the customization is facilitated through a system server utilizing machine learning and artificial intelligence to process image data and generate corresponding die-line and image files for printing and cutting operations.

In a particular embodiment, the present disclosure is related to ways for customized printing and/or cutting. A system is provided that can be particularly suited for printing individual two dimensional images on objects (e.g., air fresheners, stickers, etc.). The system allows a user to upload an image of their choice. The user may indicate which portion of the image they would like printed. The system may also recommend certain portions of the image to be printed. For example, the user can upload a picture of a dog, and then indicate that they would like only the dog's head to be printed. The system, using machine learning and/or artificial intelligence, may automatically apportion or segment or crop the image as indicated by the user, in real time. The system may produce a die-line file (e.g., an outline of the shape to be cut) and the image file to be printed on the object. These files may be transmitted to be printed and cut in accordance with the die-line files and image files to produce a customized printed product.

In one embodiment, a computer-implemented method for manufacturing a customized printed product comprises steps of providing a system server with a processor and a memory, which stores a plurality of modules including tangible, non-transitory, processor executable instructions. These modules consist of a communication module and an apportionment module. The communication module is tasked with receiving an image to be printed on a product blank and an identified parameter of the image for the customized printed product. Concurrently, the apportionment module is responsible for determining a die-line file and an image file to be printed on the product blank, with the die-line file outlining a die-line perimeter and surface area, and the image file defining an image file perimeter and surface area, ensuring the die-line file surface area exceeds that of the image file. The communication module is designed to create and transmit a real-time preview of the die-line and image files, which includes a superimposition of the image file surface area on the die-line file surface area, with the image file perimeter completely enclosed by the die-line perimeter, thereby defining a border between the image file perimeter and the die-line perimeter. Additionally, the apportionment module employs manual selection, machine learning, or artificial intelligence to apportion the image and generate the image file and the die-line file. The method includes steps for the communication module to receive the image and identified parameter, for the apportionment module to determine the die-line and image files based on the received image and parameter, and for the communication module to display the real-time preview to a user, facilitating the production of the customized printed product.

In another embodiment, a system for creating a customized printed product includes a system server equipped with a processor and a memory that stores a plurality of modules with tangible, non-transitory, processor executable instructions. These modules comprise a communication module and an apportionment module. The communication module is designed to receive an image and an identified parameter of the image for the customized printed product, which is to be printed on a product blank. The apportionment module is responsible for determining a die-line file and an image file for printing on the product blank, with the die-line file outlining a die-line perimeter and surface area, and the image file defining an image file perimeter and surface area, ensuring the die-line file surface area is larger than the image file surface area. The communication module is also configured to create and transmit a real-time preview of the die-line and image files, which includes a superimposition of the image file surface area on the die-line file surface area, with the image file perimeter completely enclosed by the die-line perimeter, thus defining a border between the image file perimeter and the die-line perimeter. Furthermore, the apportionment module employs methods such as manual selection, machine learning, or artificial intelligence to segment the image and generate the image file and the die-line file. The system server is programmed to receive the image and identified parameter via the communication module, determine the die-line and image files through the apportionment module based on the received image and parameter, and display the preview in real-time via the communication module to the user, thereby enabling the production of the customized printed product.

In a further embodiment, a computer-implemented method for manufacturing a customized printed product involves a system server that is equipped with a processor and a memory, the latter of which stores a plurality of modules including a communication module and an apportionment module. The apportionment module employs artificial intelligence to analyze an image uploaded by a user and automatically generates a variety of available crop types based on the content of the image. The communication module then provides the user with previews of each available crop type, enabling the user to manually select a preferred crop type from the options provided. Following the user's selection, the apportionment module generates a die-line file and an image file corresponding to the chosen crop type, which are then used in the production of the customized printed product. This method streamlines the customization process, allowing users to easily visualize and select the desired aspects of their printed product, ensuring that the final product aligns with their specific requirements and preferences.

In an additional embodiment, a system for manufacturing a customized printed product comprises a system server that is outfitted with a processor and a memory. This memory houses a variety of modules, including tangible, non-transitory, processor executable instructions. Among these modules are an apportionment module and a communication module. The apportionment module is specially configured to employ artificial intelligence in analyzing an image that a user has uploaded, with the capability to automatically generate multiple crop types based on the image's content. Concurrently, the communication module is designed to present the user with previews of these crop types, thereby enabling the user to manually select their preferred crop type from the array of options available. This selection is then used to facilitate the production of the customized printed product, ensuring that the system caters to the user's specific design preferences and requirements for their unique printed item.

In yet another embodiment, a computer-implemented method for manufacturing a customized printed product includes providing a system server that is equipped with a processor and a memory, the latter of which stores a plurality of modules such as a communication module and an apportionment module. The communication module is responsible for receiving either audible or typewritten instructions from a user, which include specific commands for the creation of the customized printed product. The apportionment module then utilizes artificial intelligence to analyze an image based on these instructions and generates a custom crop type that aligns with the specific commands provided by the user. Following this, the communication module presents a final product preview to the user for their approval. Once the user approves, the apportionment module proceeds to generate a die-line file and an image file necessary for the production of the customized printed product. Notably, the artificial intelligence is configured to automatically apportion or crop the image in real-time as indicated by the user's instructions, thereby streamlining the customization process and ensuring that the final product meets the user's exact specifications.

In yet a further embodiment, a system for manufacturing a customized printed product includes a system server equipped with a processor and a memory that stores a suite of modules featuring tangible, non-transitory, processor executable instructions. Among these modules are a communication module and an apportionment module. The communication module is adept at receiving either audible or typewritten instructions from a user, which contain specific commands for the creation of the customized printed product, and it is also tasked with providing a final product preview for the user's approval. The apportionment module leverages artificial intelligence to analyze an image following the user's instructions and to generate a custom crop type based on those specific commands. Upon receiving user approval, this module is further configured to generate a die-line file and an image file, which are essential for the production of the customized printed product. A key feature of this system is the artificial intelligence's capability to automatically apportion or crop the image in real-time as directed by the user's instructions, ensuring a tailored and efficient approach to product customization.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating a customized printing system, according to a first embodiment of the present disclosure;

FIG. 2 is a flowchart illustrating a computer-implemented method for manufacturing a customized printed product using the system from FIG. 1, according to the first embodiment of the present disclosure;

FIG. 3 is a flowchart further illustrating the computer-implemented method for manufacturing a customized printed product from FIG. 2;

FIG. 4 is a flowchart further illustrating the computer-implemented method for manufacturing a customized printed product from FIG. 2;

FIG. 5 is a flowchart further illustrating the computer-implemented method for manufacturing a customized printed product from FIG. 2;

FIG. 6 is a flowchart further illustrating the computer-implemented method for manufacturing a customized printed product from FIG. 2;

FIG. 7 is a flowchart further illustrating the computer-implemented method for manufacturing a customized printed product from FIG. 2;

FIG. 8 is a flowchart further illustrating the computer-implemented method for manufacturing a customized printed product from FIG. 2;

FIG. 9 is a flowchart further illustrating the computer-implemented method for manufacturing a customized printed product from FIG. 2;

FIG. 10 is a block diagram illustrating a customized printing system, according to a second embodiment of the present disclosure.

FIG. 11 is a flowchart illustrating a computer-implemented method for manufacturing a customized printed product using the system from FIG. 10, according to the second embodiment of the present disclosure;

FIG. 12 is a block diagram illustrating a customized printing system, according to a third embodiment of the present disclosure;

FIG. 13 is a flowchart illustrating a computer-implemented method for manufacturing a customized printed product using the system from FIG. 12, according to the third embodiment of the present disclosure;

FIGS. 14-29 illustrate various examples for creating a custom printed product using the system shown in FIG. 1, according to further embodiments of the disclosure;

FIG. 30 is a schematic depicting a system for manufacturing a customized printed product, according to the first embodiment shown in FIG. 1; and

FIG. 31 is an example flowchart illustrating a system for manufacturing a customized printed product, according to the first embodiment shown in FIG. 1, with broken lines indicating networked communicative connections between components of the system that may be selective or intermittent and that are not necessarily continuous in nature.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

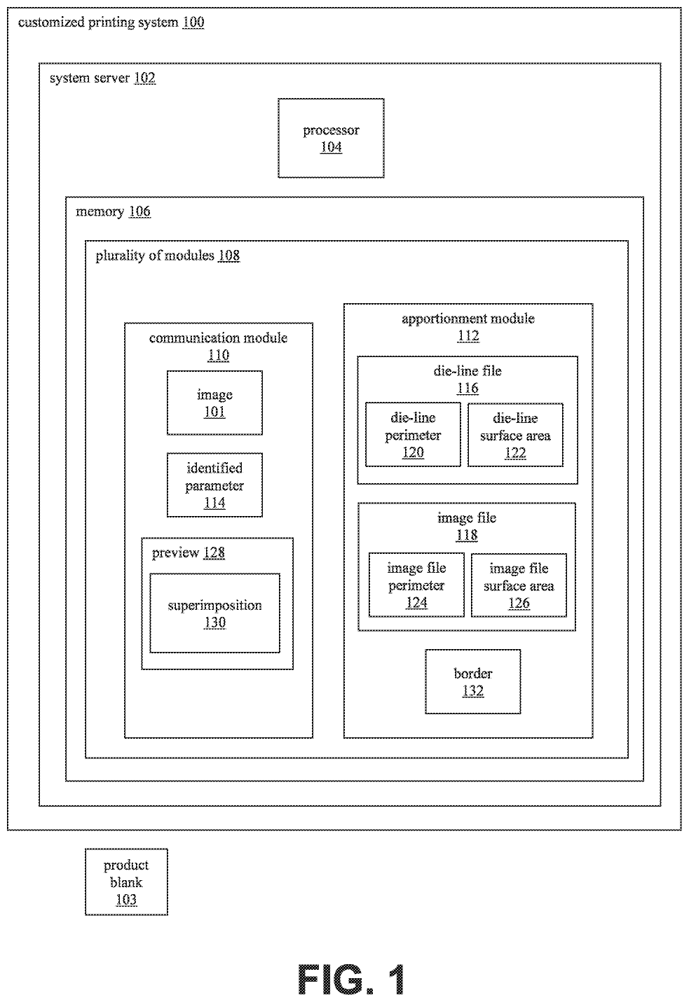

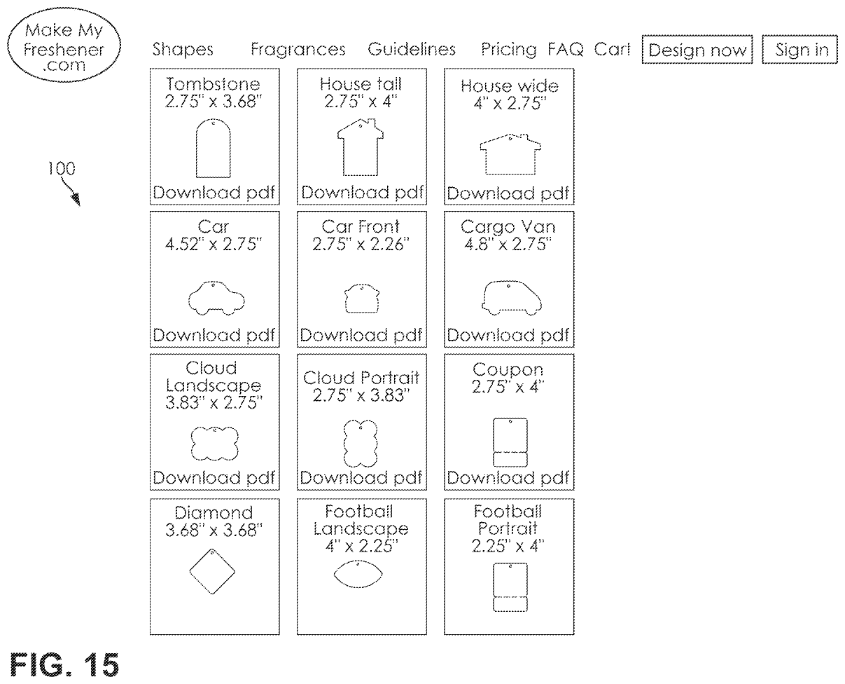

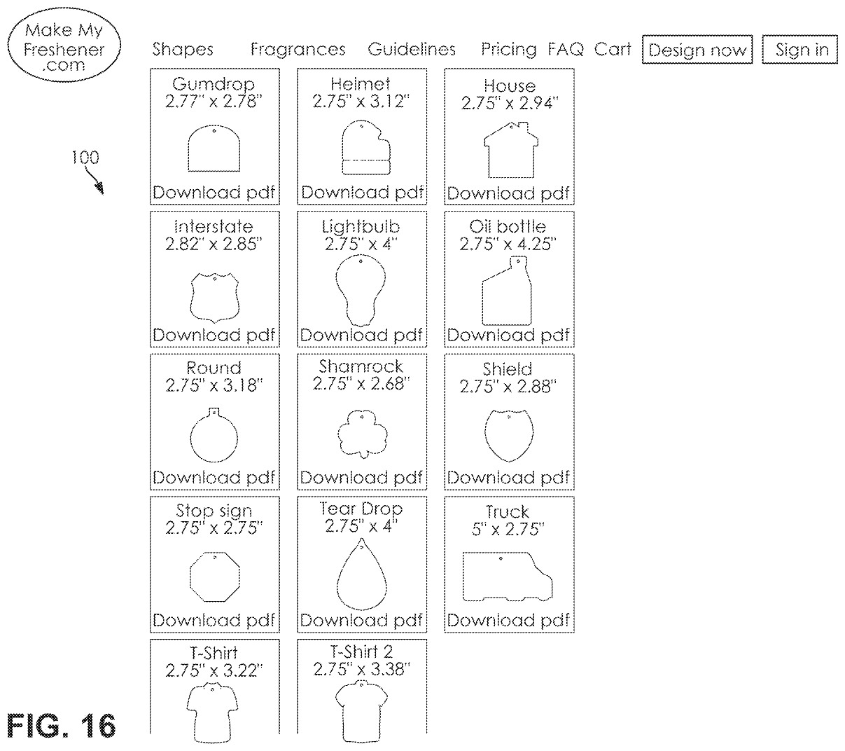

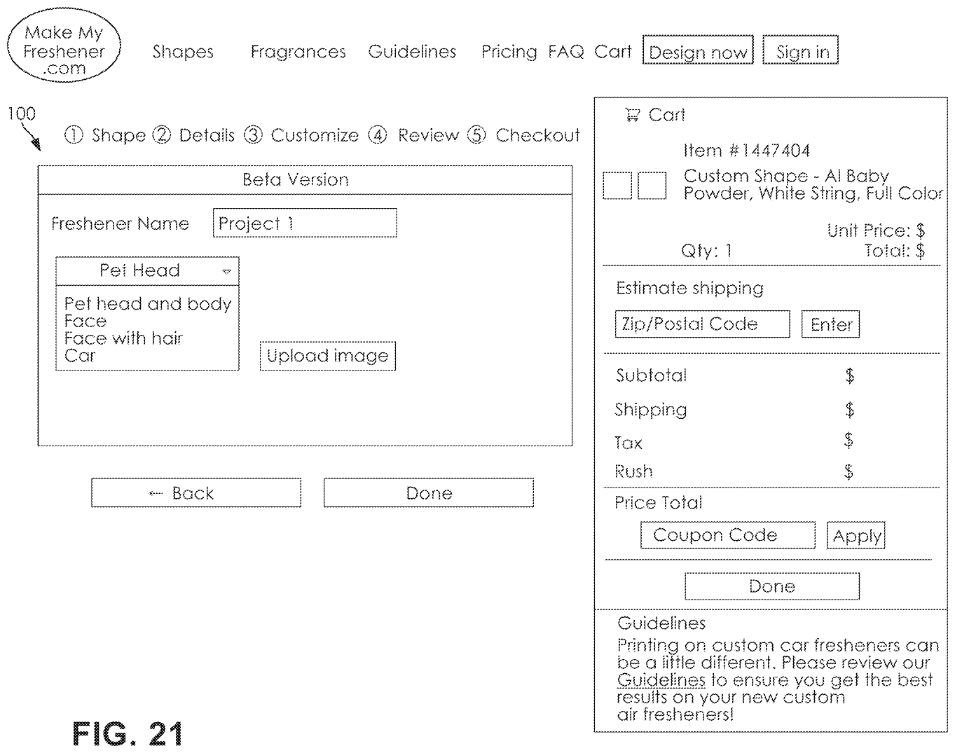

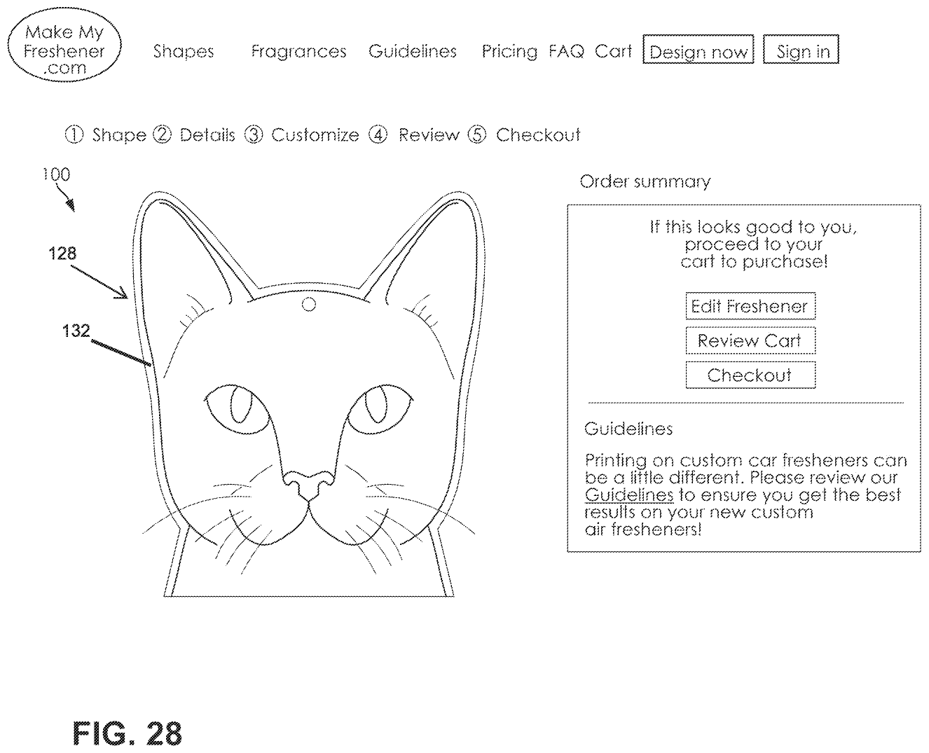

The present technology improves upon existing customized printing systems and methods by introducing advanced customized printing systems 100, 300, 500 and corresponding methods 200, 400, 600, as depicted in the accompanying FIGS. 1-31, for the efficient production of customized printed products 105. These improvements are realized through the ability of the systems and methods to allow users to customize the content of an image with precision and have it printed on a variety of products. The customized printing systems 100, 300, 500, when operated in accordance with the methods 200, 400, 600, facilitate the generation of customized printed products 105 by leveraging machine learning and artificial intelligence to automate and streamline the process of image selection, die-line file creation, and image file generation. This results in a user-friendly experience that minimizes errors and inefficiencies, thereby enhancing the overall quality and customization capabilities of the customized printed products 105.

The advanced customized printing systems 100, 300, 500 and corresponding methods 200, 400, 600 are further described hereinbelow with respect to various embodiments, which detail the integration of user interfaces, real-time preview capabilities, and the seamless transition from image upload to final product creation, all while utilizing artificial intelligence and machine learning to ensure precise alignment and customization of printed images on products.

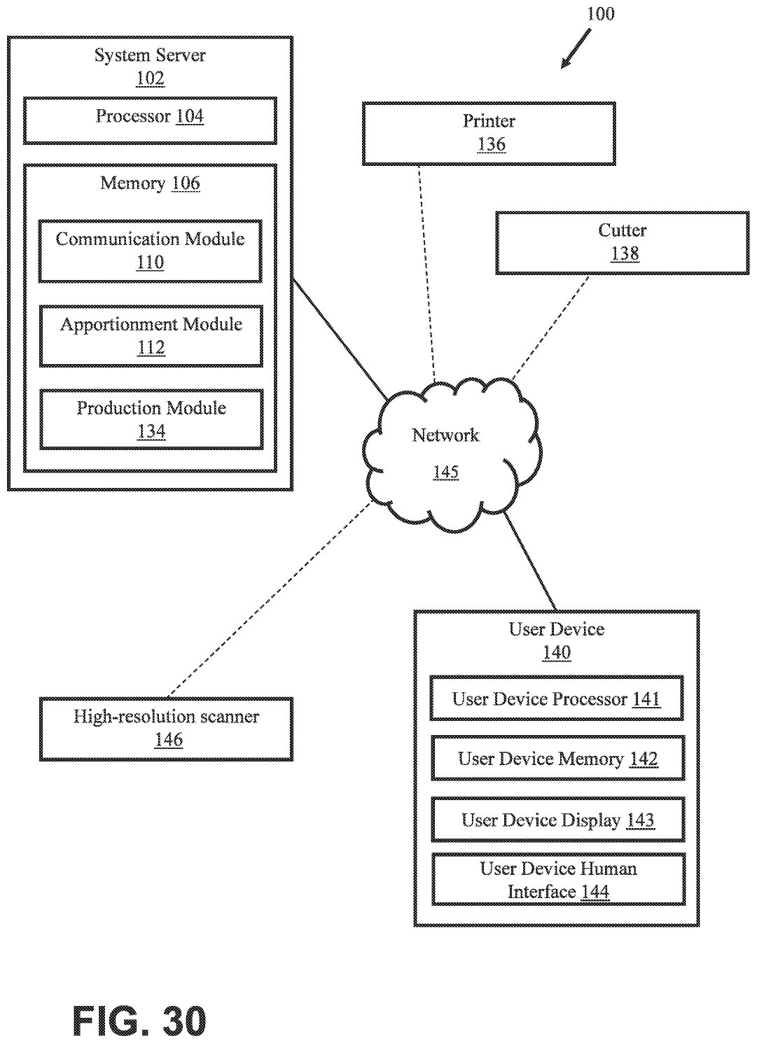

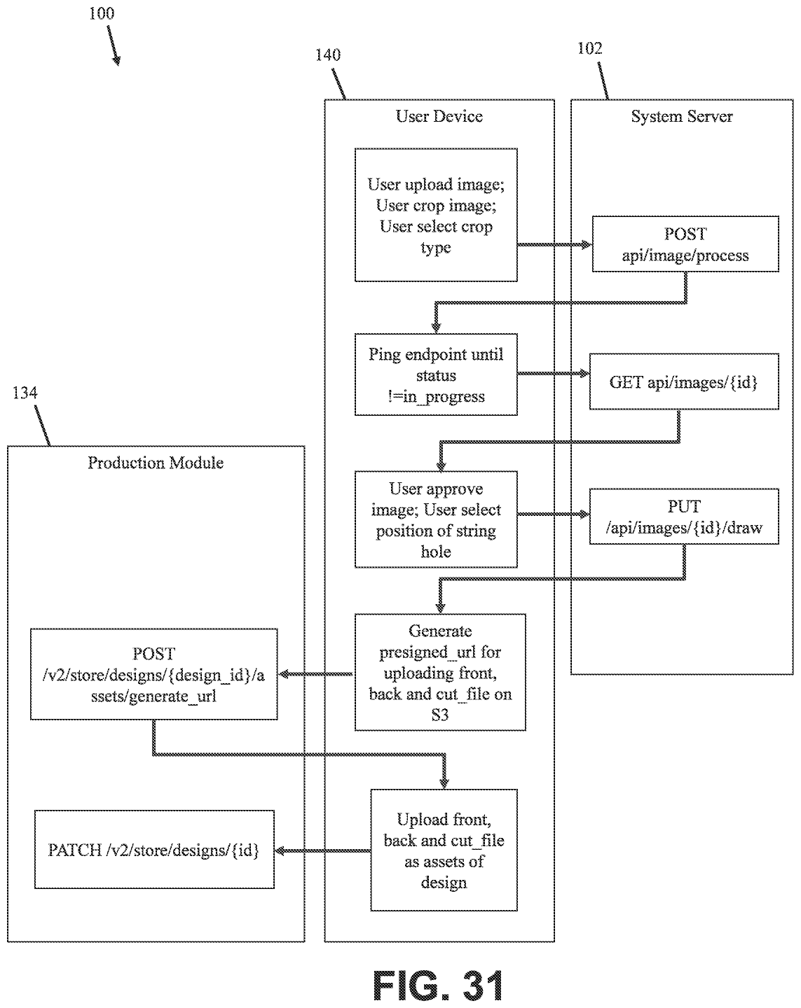

FIG. 1 is a block diagram that describes a customized printing system 100, according to a first embodiment of the present disclosure. The customized printing system 100 is also depicted, together with additional components or structure contemplated and discussed further herein, in FIGS. 30-31.

Referring to FIG. 1, the customized printing system 100 may include one or more computing platforms in the form of at least one system server 102. The at least one system server 102 can be communicably coupled with a plurality of remote platforms, for example, via at least one network. In some cases, administrators or users can access the system 100 via the plurality of remote platforms. It should be appreciated that, depending on the situation, the at least one system server 102 can therefore be provided as either a standalone system or a distributed system with the steps distributed across more than one platform.

The one or more computing platforms can also be communicatively coupled to the remote platforms. In some cases, the communicative coupling can include communicative coupling through a networked environment such as the at least one network. The networked environment can be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms and remote platforms can be operatively linked via some other communication coupling. The one or more computing platforms can be configured to communicate with the at least one network via wireless or wired connections. In addition, in an embodiment, the system server 102 can also include one or more hosts or servers, such as the at least one system server 102 connected to the network through wireless or wired connections. According to one embodiment, the at least one system server 102 can be implemented in or function as web servers, mail servers, application servers, etc. According to certain embodiments, the at least one system server 102 can be standalone servers, networked servers, or an array of servers. In an embodiment, the plurality of remote platforms can be configured to communicate directly with each other via wireless or wired connections. Examples of the plurality of remote platforms can include, but are not limited to, smartphones, wearable devices, tablets, laptop computers, desktop computers, Internet of Things (IoT) devices, or other mobile or stationary devices.

With continued reference to FIG. 1, the system server 102 can include a processor 104 and a memory 106. It should be appreciated that the memory 106 of the at least one system server 102 can further include or be coupled to or more processors such as the processor 104, for storing information and instructions that can be executed by the system server processor. The memory 106 can be one or more memories and of any type suitable to the local application environment and can be implemented using any suitable volatile or nonvolatile data storage technology such as a semiconductor-based memory device, a magnetic memory device and system, an optical memory device and system, fixed memory, and removable memory. For example, the memory 106 can consist of any combination of random-access memory (RAM), read only memory (ROM), static storage such as a magnetic or optical disk, hard disk drive (HDD), or any other type of non-transitory machine or computer readable media. The instructions stored in the system server memory can include program instructions or computer program code that, when executed by the processor 104, enable the at least one system server 102 to perform tasks as described herein.

One skilled in the art will also appreciate that the one or more processors 104 of the at least one system server 102 can be configured for processing information and executing instructions or operations. The processor 104 can be any type of general or specific purpose processor. In some cases, multiple processors for the system processor 104 can be utilized according to other embodiments. In fact, the one or more of the system processors 104 can include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more of the processors 104 can be remote from the at least one system server 102, such as disposed within a remote platform like the one or more remote platforms of FIG. 1.

With further reference to FIG. 1, the at least one memory 106 may store or otherwise include a plurality of modules 108 containing tangible, non-transitory, processor executable instructions. The at least one memory 106 may store or otherwise include a plurality of databases. The plurality of modules 108 may include a communication module 110 and an apportionment module 112, for example. The plurality of modules may further include a production module 134 in certain embodiments. Other suitable modules for execution by the one or more processors 108 to perform functions associated with the operation of system 100 may also be employed within the scope of the present disclosure, as desired.

The communication module 110 may be configured to receive an image 101 to be printed on a product blank 103 and an identified parameter 114 of the image 101 for the customized printed product 105. The product blank 103 may include one or more of an air freshener, a sticker, a label, a decal, a temporary tattoo, an iron-on, a patch, a magnet, and a badge, as non-limiting examples. One of ordinary skill in the art may select other product blanks 103 within the scope of the present disclosure.

As used herein, the term “identified parameter” is defined as a specific characteristic or attribute of an image that has been selected or determined for use in the customization process. This parameter can be a particular portion of the image, such as a region of interest or a feature that the user wishes to highlight or isolate for printing. It serves as a critical input for the apportionment module 112, guiding the apportionment process to focus on and extract the relevant part of the image that will be used to create the customized printed product 105. The identified parameter may be manually chosen by the user or automatically suggested by the system's artificial intelligence based on the content of the image and the desired outcome of the customization, as described further herein.

The apportionment module 112 may be configured to determine a die-line file 116 and an image file 118 to be printed on the product blank 103. The die-line file 116 may define a die-line perimeter 120 and a die-line file surface area 122. As used herein, the term “die-line perimeter” means the outline or boundary that defines the exact shape to be selected for or cut from a substrate in the production of printed materials. It is a critical component of the die-line file, which guides cutting instruments during the manufacturing process to ensure the final product adheres to the desired specifications. As also described further herein, the die-line perimeter typically encompasses a larger area than the image file perimeter, providing a margin or border around the printed image, which not only secures the integrity of the image within the final cut shape but also contributes to the aesthetic quality of the end product.

The image file 118 may define an image file perimeter 124 and an image file surface area 126. The die-line file surface area 122 may be greater than the image file surface area 126. As used herein, the term “image file perimeter” means the outline that delineates the edges of the actual image intended for printing on a product. It is the boundary that encases the visual content or graphics of the image file, dictating the area that the printed image will occupy. This perimeter is designed to be within the confines of the larger die-line perimeter, as described above, allowing for a margin around the image which can serve both functional and aesthetic purposes in the final printed product. The image file perimeter is a crucial aspect of the pre-production process, ensuring that the image is correctly positioned and sized for the intended application.

The image 101 received by the communication module 110 may be a digital image. The digital image may be uploaded to the communication module 110 by the Alternatively, the user may select the image 101 from an image asset database, which may also be stored on the memory. The image asset database may be configured to retrieve or store a plurality of digital images from or on an online server. The image asset database may include thumbnails or links to the actual image files stored on the online server. The image files stored on the online server may include those uploaded by other users. The digital image may be provided in various digital file formats. A non-limiting example of the digital file formats may include, but are not limited to, JPG, GIF, TIFF, PNG, or BMP files. One of ordinary skill in the art may select suitable digital file formats within the scope of the present disclosure.

In a particular embodiment, the communication module 110 may further be configured to receive digital videos. For example, the user may upload a digital video and may request that a certain frame be captured. At least one of the communication module 110 and the apportionment module 112 may be configured to generate one or more frames from the digital video. The digital images and videos may be provided by any number of sources. Additionally, the communication module 110 may include functionality to allow the user to specify the exact timestamp or scene from which to extract the frame, ensuring that the selected frame accurately represents the desired content for the customized printed product 105. This feature enhances the system's versatility, enabling users to source imagery from dynamic content and providing a richer set of options for personalization.

With reference to FIG. 1, the communication module 110 may also be configured to create a preview 128 of the die-line file 116 and the image file 118, in real-time, and transmit the die-line file 116 and the image file 118, once the communication module 110 receives the image 101. This real-time preview 128 enables users to visualize how the final printed product will appear after the image 101 is applied within the boundaries set by the die-line file 116. The ability to instantly see and approve the preview 128 before transmission ensures that any adjustments or corrections can be made promptly, thereby streamlining the production process and enhancing user satisfaction with the end result.

In a particular embodiment, the preview 128 may include a superimposition 130 of the image file surface area 126 on the die-line file surface area 122 such that the image file perimeter 124 may be bounded entirely by the die-line perimeter 120 and a border 132 may be defined as an area between the image file perimeter 124 and the die-line perimeter 120. Effectively, this reduces and militates against any error in the printed product as it allows the user to see the custom printed product before production. The inclusion of the border 132 ensures that the final product has a clean and professional appearance, with the image properly centered and aligned within the die-cut shape. This feature is particularly beneficial for quality assurance, as it provides a clear and accurate representation of the end product before the manufacturing process begins, allowing for any necessary adjustments to be made in advance.

Non-limiting examples of widths for the border 132 may vary depending on the size and shape of the product being manufactured. For instance, in the case of a small custom sticker, the border 132 might be as narrow as 1-2 millimeters to ensure the image is maximally displayed while still providing a clean edge after cutting. For larger items, such as custom printed signage or personalized air fresheners, the border 132 could be wider, potentially ranging from 5 millimeters to 1 centimeter or more, to accommodate the increased product size and to enhance the visual framing of the printed image. In products where the die-line includes intricate shapes or curves, the border 132 width may be adjusted accordingly to ensure consistent aesthetics and structural integrity across all edges of the product. The border 132 may also be generated in a way such that there is a tapered, varying, or otherwise inconsistent width along the length of the border 132. It is important to note that the specific width of the border 132 can be tailored to meet the design preferences of the user or the practical requirements of the printing and cutting equipment used in the manufacturing process.

Additionally, the system server 102 may be configured to receive, by the communication module 110, the image 101 to be printed on the product blank 103 and the identified parameter 114 of the image 101 for the customized printed product 105. The system server 102 may also be configured to determine, by the apportionment module 112, the die-line file 116 and the image file 118 for the product blank 103 based on the image 101 received and the identified parameter 114. Further, the system server 102 may be configured to display the preview 128 in real-time, by the communication module 110, of the die-line file 116 and the image file 118 to a user for production of the customized printed product 105.

With further reference to FIG. 1, the apportionment module 112 may be configured to utilize at least one of manual selection, machine learning, and artificial intelligence to apportion the image 101 to generate the image file 118 and the die-line file 116. This multifaceted approach allows for a high degree of customization and precision in the creation of the printed product. Manual selection empowers users to directly influence the design process, while machine learning and artificial intelligence provide sophisticated tools for analyzing the image and automating the generation of the die-line and image files, ensuring that the final product aligns with the user's specifications and quality expectations.

In a particular embodiment, the apportionment module 112 may also be configured to segment the image 101 and place or superimpose the image 101 on another two-dimensional image of a three-dimensional product, for example, in order to provide an example or proof of the printed product based on the user's initial request.

As used herein, the term “segmentation” is referred to as a type of apportionment performed by the apportionment module 112, and involves the strategic division of a digital image into distinct sections or segments. This segmentation can leverage advanced algorithms to dissect the image into meaningful parts, which could correspond to specific features or objects within the image, such as the head of a pet or a particular shape. The apportionment module 112 may be equipped with sophisticated machine learning and artificial intelligence capabilities, for example, to meticulously execute this segmentation process. The apportionment module 112 can identify and isolate the desired segments based on user directives or pre-established parameters, facilitating the creation of customized printed products 105 that precisely match the user's specifications. This intelligent segmentation not only enhances the customization experience but also streamlines the production workflow by providing precise input for the subsequent printing and cutting stages.

As one non-limiting example, the user may input a request to print an image of their dog on a mug. This would not require a die-line file 116, as no cutting would be required. However, this will produce the image file 118 and the apportionment module 112 may segment or otherwise crop the image of the dog on another image of the mug for purposes of the preview, in real-time. Advantageously, the user may modify the request to their liking or may accept the preview to transmit to the production module 134. Furthermore, the preview allows the user to modify the project to militate against mistakes in the final printed product.

Although some of examples provided herein describe the apportionment of images in the context of segmentation, it should be appreciated that the present disclosure is not limited to just segmentation as a form of apportionment. Other suitable forms of apportionment may also be employed within the scope of the present disclosure, as desired.

With continued reference to FIG. 1, the apportionment module 112 may be configured to scale the die-line file 116 and the image file 118 against the size of the product blank 103 for production and printing. More specifically, the apportionment module 112 may automatically size the die-line file 116 and the image file 118 to be less than the overall size of the product blank 103. This allows the image file 118 to be entirely depicted on the custom printed product once the product blank 103 goes through the printer 136 in the production module 134. As a non-limiting example, the dimensions of the image file 118 may be less than the dimensions of the shape of the product blank 103, which may further be defined by the border 132 around the image file perimeter 124 on the custom printed product. The border 132 may entirely surround the image file perimeter 124. Advantageously, this militates against potential cutting of the image 101 during production.

Referring to FIGS. 30-31, in certain embodiments the system 100 may also include the production module 134. The production module 134 may be in communication with the communication module 110 and the apportionment module 112. The communication module 110 may be configured to transmit the die-line file 116 and the image file 118 to the production module 134 upon user approval to manufacture the customized printed product 105. The production module 134 is equipped to handle the physical realization of the product, utilizing the transmitted die-line and image files to accurately print and cut the customized design. This module may include advanced printing and cutting machinery software capable of processing various materials and ensuring that the final product adheres to the precise specifications set forth in the user-approved preview. The integration of the production module 134 within the system 100 streamlines the manufacturing workflow, allowing for a seamless transition from digital design to tangible product.

The customized printing system 100 further may likewise include a printer 136 and a cutter 138. As non-limiting examples, the printer 136 may include various types of printing technologies such as inkjet, laser, thermal, dye-sublimation, or digital offset printing systems. Each technology offers distinct advantages; for instance, inkjet printers are renowned for their ability to produce high-resolution images with vibrant colors, making them ideal for detailed graphics on custom products. Laser printers, on the other hand, are valued for their speed and efficiency, particularly suitable for high-volume print runs with consistent quality. Thermal printers provide durability and are often used for printing on specialized materials, whereas dye-sublimation printers excel in creating photographic quality prints with a smooth color gradient, perfect for intricate designs. Digital offset printers combine the advantages of traditional offset printing, such as high image quality and the ability to use a wide range of materials, with the flexibility and efficiency of digital printing. The choice of printer within the customized printing system 100 can be tailored to the specific needs of the product being manufactured, taking into account factors such as the type of material, the complexity of the image, production speed requirements, and the desired finish of the printed product.

As further non-limiting examples, the cutter 138 may be configured to perform any of the following: die-cutting, which is ideal for creating precise and repeatable shapes in a variety of materials; plotting cutting, which offers intricate detail for sticker and decal production; vibe knife cutting, suitable for cutting soft materials or multi-layered fabrics; reciprocating knife cutting, which is effective for thicker and more rigid materials; router cutting, often used for hard materials like wood, metal, or acrylic; or laser cutting, which provides exceptional precision and can be used for a wide range of materials, including plastics, textiles, and metals. Each cutting technology brings its own set of capabilities to accommodate different material properties and thicknesses, ensuring clean edges and accurate dimensions. The selection of a cutting method within the customized printing system 100 can be based on the specific requirements of the custom printed product, such as the complexity of the design, the durability needed in the final product, and the production throughput rates. By offering a variety of cutting options, the system can cater to a diverse range of custom manufacturing applications, from promotional items and packaging to bespoke products and intricate component parts.

In a particular embodiment, each of the printer 136 and the cutter 138 may be placed in communication with the production module 134, either selectively by the user on an as-needed basis, or continuously via a network. Specifically, the printer 136 may be in communication with the production module 134 and may be configured to print the image 101 on an outer surface of the product blank 103 in dependence on the image file 118. The cutter 138 may be in communication with the production module 134 and may be configured to cut a shape out of the product blank 103 in dependence on the die-line file 116 to form the customized printed product 105. This configuration allows for a highly automated and efficient production process, where the transition from digital design to physical product is streamlined, reducing the potential for human error and increasing the consistency and quality of the final customized printed products 105.

In an even more particular embodiment, the printer 136 and the cutter 138 may be integrated within a single machine. The single machine may be configured to both print the image 101 on the outer surface of the product blank 103 based on the image file 118 as well as cut the shape out of the product blank 103 based on the die-line file 116. Advantageously, the customized printing system 100 reduces the need for multiple systems to create a customized printed product 105. This integration simplifies the manufacturing process by consolidating printing and cutting functions, which can lead to a more streamlined production workflow, reduced equipment costs, and a smaller footprint on the production floor. Additionally, by combining these processes into one machine, the alignment and registration between the printed image and the cut shape can be more precisely controlled, resulting in a higher quality finished product with greater detail and accuracy.

Alternatively, the printer 136 and the cutter 138 may be provided as separate components from the customized printing system 100, but may be selectively placed in communication the customized printing system 100 to produce the custom printed product. Specifically, the printer 136 and the cutter 138 may be integrated within separate machines. In some embodiments, the printer 136 of the production module 134 may be provided as a first machine and the cutter 138 of the production module 134 may be provided as a second machine. The first machine may be selectively placed in communication with the second machine such that the customized printed product 105 being manufactured may be passed automatically, for example, via transfer equipment such as belts, robot picking arms, and the like, from the first machine to the second machine. In the alternative, the customized printed product 105 may be manually transferred by the user from the first machine to the second machine. One of ordinary skill in the art may select a suitable configuration for the production module 134 within the scope of the present disclosure.

The customized printing system 100 may further include a user device 140 having a user device processor 141, a user device memory 142, and at least one of a user device display 143 and a user device human interface 144, as shown in FIG. 30. The user device 140 may be in communication with the communication module 110 of the system server 102 via the wide area network 145, such as the Internet. Alternatively, the user device 140 may be in communication with the communication module 110 of the system server 102 via a local area network (LAN). The wide area network 145 may include signal bearing mediums that may be controlled by software, applications, and/or logic. The wide area network 145 may also include a combination of network elements to support data communication services and may also encompass wired and/or wireless network technologies. One of ordinary skill in the art may select a suitable communications network for the user device 140 to communicate with the communication module 110 within the scope of the present disclosure.

The at least one of the user device display 143 and the user device human interface 144 are each configured to permit the user to interact with the communication module 110. Further, the user device processor 141 may be configured to execute instructions stored on the user device memory 142 to facilitate the interaction between the user and the communication module 110.

The user device human interface 144 may include at least one of a keyboard, a mouse, a touchscreen, a microphone for receiving audible commands, and a camera for capturing images and videos to be uploaded to the communication module 110. Additionally, the user device human interface 144 may be equipped with other input devices such as a stylus for precision input on touchscreens, a trackpad for gesture-based navigation, or even virtual reality (VR) and augmented reality (AR) interfaces that allow for immersive interaction with the system. These interfaces can provide the user with a more intuitive and natural way to design and preview customized printed products 105. Furthermore, the user device human interface 144 may support biometric inputs, such as fingerprint scanning or facial recognition, for secure authentication and personalized settings, enhancing the overall user experience and security of the customized printing system 100.

Additionally, the user device memory 142 may include or store processor-executable code for a browser application or a dedicated application that facilitates the communication between the user device 140 and the communication module 110 over the wide area network 145. This software may be optimized for efficient data transfer and user-friendly navigation, ensuring that high-resolution images and complex design files can be uploaded and downloaded swiftly and reliably. The user device 140 may further include a desktop computer, a laptop computer, a tablet, a smartphone, or a wearable device. Each type of device may offer different advantages, such as larger screens for detailed design work on desktops and laptops, or portability and convenience with tablets and smartphones. Wearable devices could provide notifications and status updates on the printing process, enhancing the mobility and flexibility for users who need to multitask. One of ordinary skill in the art may select a suitable user device 140 to use with the customized printing system 100 within the scope of the present disclosure, taking into account factors such as the user's mobility, the complexity of the printing tasks, and the preferred method of interaction with the system. Compatibility with various operating systems and hardware configurations can also be considered to ensure a broad accessibility for users with different technology preferences.

In further embodiments, the customized printing system 100 may include a high-resolution scanner 146 integrated with the production module 134. The high-resolution scanner 146 may be configured to capture detailed images of the printed products post-manufacture for quality control purposes. The processor 104 of the system server 102 may be configured to compare captured images with the image file 118 using a machine learning model to ensure that the customized printed product 105 adheres to predetermined quality standards before dispatch. This automated quality control process can significantly reduce the time and labor traditionally required for manual inspection, while also increasing the consistency and reliability of the final product quality. The machine learning model may be trained on a dataset of approved and rejected products to improve its accuracy over time, learning to identify even the most subtle deviations from the quality standards. One of ordinary skill in the art may determine the predetermined quality standards within the scope of the present disclosure, which may include parameters such as color fidelity, image sharpness, and alignment accuracy. Additionally, the system may be configured to provide feedback and corrective actions to the production module 134 if any discrepancies are detected, further streamlining the manufacturing process and reducing waste.

It should also be appreciated that the customized printing system 100 may further include a graphical processing unit (GPU) within the system server 102, as a particular type of the at least one processor 104. Alternatively, the customized printing system 100 may include a central processing unit (CPU) within the system server 102 as the at least one processor 104. Each of the GPU and CPU may be configured to accelerate the processing of complex image analysis and machine learning tasks related to the manufacture of the customized printed product 105. Further, the GPU or CPU may be utilized by the communication module 110 to enable rapid generation and real-time rendering of the preview 128 of the die-line file 116 and the image file 118, which further enhances the user experience by providing immediate visual feedback on customization choices. One of ordinary skill in the art may select whether to implement a GPU or CPU within the system server 102 for operation of the system 100 and associated methods within the scope of the present disclosure, as desired.

As one non-limiting example, the customized printing system 100 may also include an instant segmentation tool to crop and segment the images uploaded by the user. The instant segmentation tool may utilize a combination of machine learning and artificial intelligence. As a non-limiting example, the machine learning model may include the Mask RCNN model for the instant segmentation tool which may run on the Django™ framework, which is an open-source framework that serves as the backend application programming interface (API). As a non-limiting example, this allows the requests in the system to trigger the model for the instant segmentation of the uploaded image, and further allows the system to process and save the images. One of ordinary skill in the art may select alternative frameworks to run the instant segmentation tool of the customized printing system, as well as alternative processors to run the customized printing system, within the scope of the present disclosure.

As a further non-limiting example, the customized printing system 100 may incorporate the Yolov8™ framework for use of artificial intelligence model to support detection, segmentation, and classification of the image 101 to create the identified parameter 114, the die-line file 116, the image file 118, and to transmit each to the production module 134. One of ordinary skill in the art may select a suitable model to implement into the customized printing system 100. As a non-limiting example, one of ordinary skill in the art may incorporate RCNN into the customized printing system 100. The Yolov8 model allows the customized printing system 100 to run on the user's mobile device which allows the user to communicate to the customized printing system 100 displayed through the mobile device, rather than through a website. It should be appreciated that one of ordinary skill in the art may select other suitable frameworks to incorporate into the customized printing system 100 within the scope of the present disclosure.

The customized printing system 100 may further comprise employing a self-optimizing machine learning framework by the system server 102 that autonomously adjusts the parameters for image analysis and die-line file 116 generation to minimize manual user intervention and maximize efficiency of the production module 134. This framework can include adaptive algorithms that learn from each production cycle, refining the system's ability to handle a diverse range of image types and material specifications with increasing precision. The self-optimizing capabilities may also extend to predictive maintenance of the production equipment, scheduling optimizations to reduce downtime, and resource allocation to balance workloads and prioritize urgent orders. By continuously analyzing production data, the machine learning framework can identify patterns and insights that lead to proactive improvements in the manufacturing process, such as adjusting print settings for different materials or modifying cutting paths to reduce material waste. The system server 102 may also utilize real-time analytics to provide users with estimated completion times and potential cost savings, enhancing the decision-making process for both the service provider and the end-user. One of ordinary skill in the art may implement such a framework within the customized printing system 100, ensuring that it remains flexible and scalable to meet the evolving demands of the market and the creative aspirations of the users.

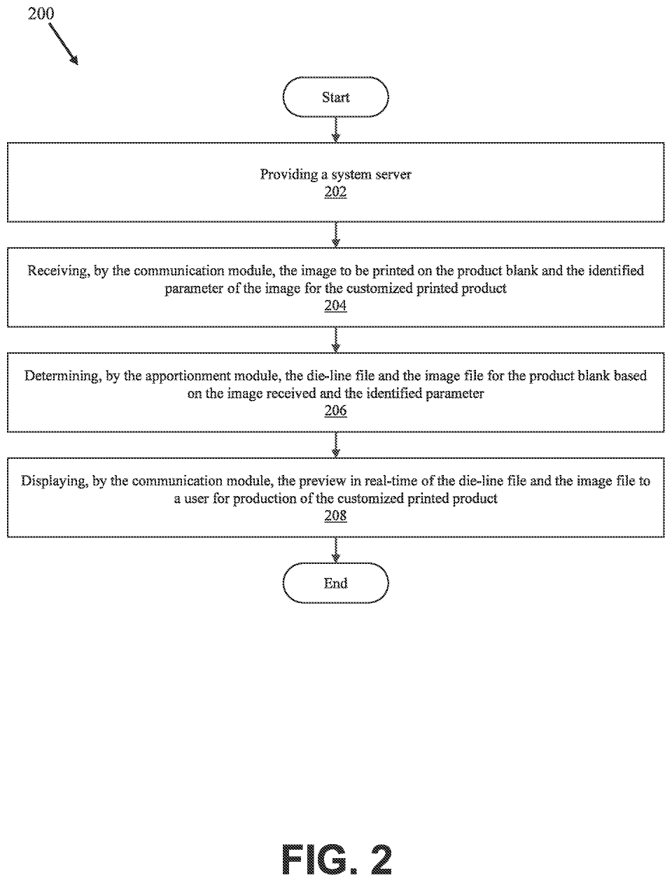

Referring now to FIG. 2, a flowchart is provided that describes a computer-implemented method 200 for manufacturing the customized printed product 105, for example, using the system 100 as described hereinabove. The computer-implemented method 200 may include a step 202 of providing the customized printing system 100 including the system server 102 as described herein. The computer-implemented method 200 may include a step 204 of receiving, by the communication module 110, the image 101 to be printed on the product blank 103 and the identified parameter 114 of the image 101 for the customized printed product 105. The computer-implemented method 200 may include a step 206 of determining, by the apportionment module 112, the die-line file 116 and the image file 118 for the product blank 103 based on the image 101 received and the identified parameter 114. The computer-implemented method 200 may include a step 208 of displaying, by the communication module 110, the preview 128 in real-time of the die-line file 116 and the image file 118 to the user for production of the customized printed product 105.

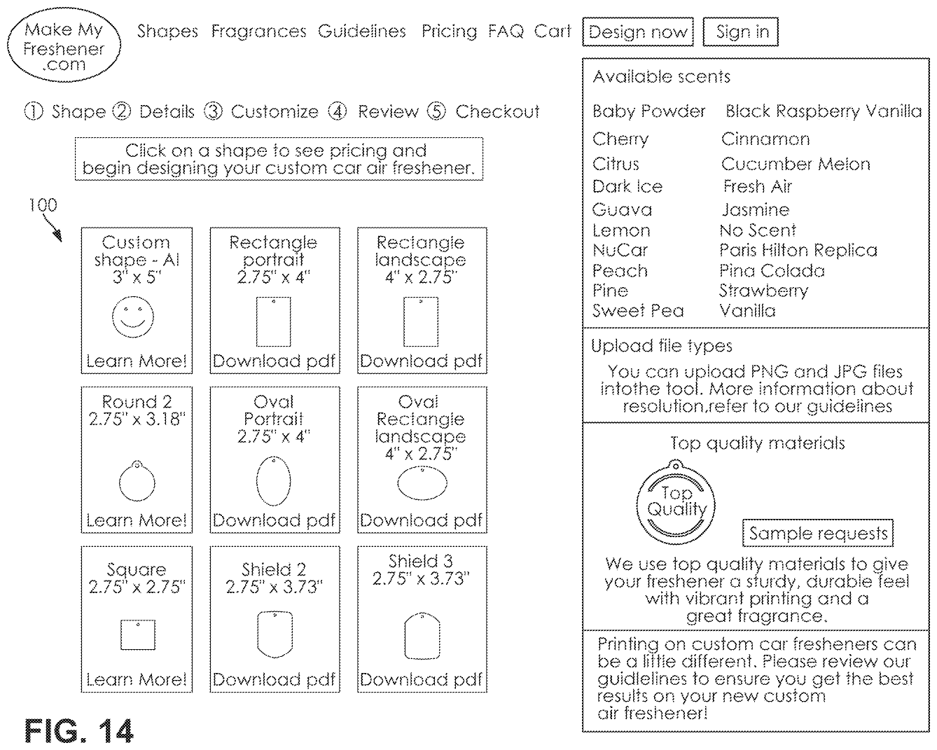

The computer-implemented method 200 may further include a step of receiving, by the communication module 110, the manual selection of a crop type from a user, which may typically occur between the step 204 and the step 206 shown in FIG. 2. Specifically, the crop type may define the identified parameter 114 and a shape to make the customized printed product 105. The user may choose from a variety of predefined crop types or may define a custom crop shape that best fits their design needs. This selection process may be facilitated by an intuitive user interface (examples shown in FIGS. 14-28) that allows the user to visually select or draw the desired crop area directly on the uploaded image. Once the crop type is selected, the apportionment module 112 can proceed to generate the corresponding die-line file 120 and image file 118, which will be used to print and cut the product. The system may also provide the user with a real-time preview of the cropped image and the expected final product shape, enabling the user to make any necessary adjustments before finalizing the design. This interactive step ensures that the user has full control over the customization of the product, leading to a more personalized and satisfactory outcome.

It should be appreciated that the computer-implemented method may incorporate advanced artificial intelligence (AI) as well in order to enhance the customization experience. For instance, upon the user's manual selection of a crop type, the AI can perform real-time image analysis to determine the best way to crop the image according to the user's specifications. This could involve identifying and focusing on key elements within the image, such as faces in a group photo or a logo in a branding image. The ability to recognize and prioritize these elements ensures that the most important parts of the image are retained during the cropping process.

The AI can also offer a variety of crop type suggestions based on the content of the image. For example, if the uploaded image is a family portrait, the AI might suggest crop types that focus on individual family members, the entire group, or even the background scenery. These suggestions are presented to the user in an easy-to-understand “mosaic” format, allowing for quick comparison and selection. The user can then review these AI-generated options and choose the one that best aligns with their vision for the customized printed product.

In the context of the present disclosure, the term “mosaic” refers to a composite preview display that the system generates to present multiple cropping options or segmentations of an uploaded image to the user. This mosaic is essentially a visual array or collage composed of several different cropped versions of the original image, each representing a unique crop type or segmentation variant suggested by the system's AI. The user can view these variations side by side within the user interface, allowing for easy comparison and selection. The mosaic serves as an interactive tool that aids users in visualizing how different portions of their image would look once printed and cut according to the various suggested outlines. By providing a mosaic of options, the system empowers users to make an informed choice about which crop type best suits their design needs for the customized printed product.

Moreover, the AI is capable of executing complex segmentation tasks, such as separating the subjects from the background or isolating specific features like clothing or accessories. This level of detail provides users with an unprecedented degree of control over the final appearance of their customized product. Once the user selects their preferred segmentation, the AI promptly generates the necessary die-line and image files, which are essential for the subsequent printing and cutting stages.

Throughout this process, the system maintains a user-friendly interface that displays a real-time preview of the cropped image. This interactive preview allows users to visualize the expected outcome and make any desired adjustments on the fly. The real-time aspect of the preview is crucial, as it provides immediate feedback and ensures that the user's creative intent is accurately captured before the product enters the production phase. The inclusion of AI in the computer-implemented method significantly streamlines the customization process, offering users a blend of automated intelligence and personal input. This synergy between AI and user choice not only simplifies the design process but also enhances the overall quality and satisfaction with the final customized printed product.

The computer-implemented method 200 may further include a step of scaling, by the apportionment module 112, the die-line perimeter 120 and the image file perimeter 124 relative to the product blank 103 for production and printing, typically performed between the step 206 and the step 208. The shape of the die-line perimeter 120 may be same as but scaled relative to a shape of the image file perimeter 124. Advantageously, the scaling of the die-line perimeter 120 and the image file perimeter 124 ensures a precise and accurate print of the image 101 on the custom printed product during production.

Either following the scaling step or as part of the scaling step performed by the apportionment module, the computer-implemented method may offer a user interface that provides a comprehensive suite of tools for users to manually adjust or refine the AI-suggested crop types and segmentations and scaling. These tools are designed to give users granular control over the final appearance of their customized printed product.

For instance, the user interface may include a drag-and-drop feature that allows users to click and adjust the corners or edges of the crop area, resizing it to include more or less of the image as needed. Additionally, lasso and brush tools can be made available for users to create more detailed selections, either by drawing freeform boundaries or by painting to add or subtract areas from the crop.

To aid in these adjustments, the interface can provide anchor points or handles around the crop area. Users can manipulate these points to alter the shape of the crop, which is particularly useful for creating custom crop shapes beyond standard rectangles or squares. The interface may also offer zoom and pan capabilities, enabling users to closely inspect the details of the crop area and navigate around the image with ease.

An essential feature of the user interface is the ability to undo and redo actions. This allows users to experiment with different crop adjustments without the fear of making irreversible changes. Users can also toggle between views of the original image and the AI-suggested crop to make informed decisions about their adjustments.

For products that require specific dimensions, an aspect ratio lock can be included to maintain the correct proportions of the crop area during resizing. As users make these manual adjustments, a live preview will update in real-time to reflect the changes, providing immediate visual feedback.

The user interface may also include advanced features such as snap-to-feature, which aligns the crop boundary with detected features within the image, and custom shape creation tools, allowing users to draw unique shapes for their crop area. Opacity and overlay adjustments can help users see how the cropped image will interact with other elements of the product.

Lastly, alignment guides, grids, and rulers can assist users in accurately positioning the crop area, ensuring that the final printed product is both well-composed and visually appealing. By integrating these user-friendly tools into the interface, the system ensures that users can easily and precisely tailor the AI-generated crop suggestions to meet their specific design requirements, leading to a more personalized and satisfactory outcome for the customized printed product.

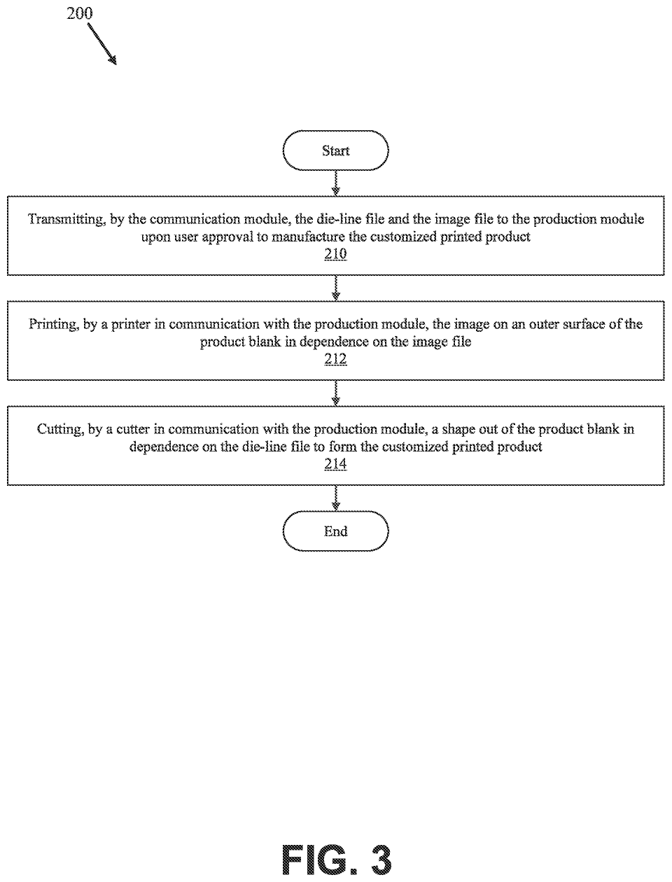

Referring now to FIG. 3, a flowchart is provided that describes additional steps to the computer-implemented method 200, particularly when the customized printing system 100 includes the production module 134, as described herein above. In particular, the computer-implemented method 200 may include a step 210 of transmitting, by the communication module 110, the die-line file 116 and the image file 118 to the production module 134 upon user approval to manufacture the customized printed product 105. The computer-implemented method 200 may include a step 212 of printing, by a printer 136 in communication with the production module 134, the image 101 on an outer surface of the product blank 103 in dependence on the image file 118. The computer-implemented method 200 may include a step 214 of cutting, by a cutter 138 in communication with the production module 134, a shape out of the product blank 103 in dependence on the die-line file 116 to form the customized printed product 105.

The computer-implemented method 200 may further include a step of leveraging, by the system server 102, an artificial intelligence module that utilizes machine learning to adaptively learn from each customization process, which may typically occur after the step 214, thereby improving system performance and user satisfaction over time. Additionally, the computer-implemented method 200 may include a step of employing, by the system server 102, a self-optimizing machine learning framework that autonomously adjusts the parameters for image analysis and die-line file generation, typically performed after the step 214, in order to minimize manual user intervention and maximize efficiency of the production module 134. Advantageously, this allows a seamless system for the user experience to produce custom printed products each time.

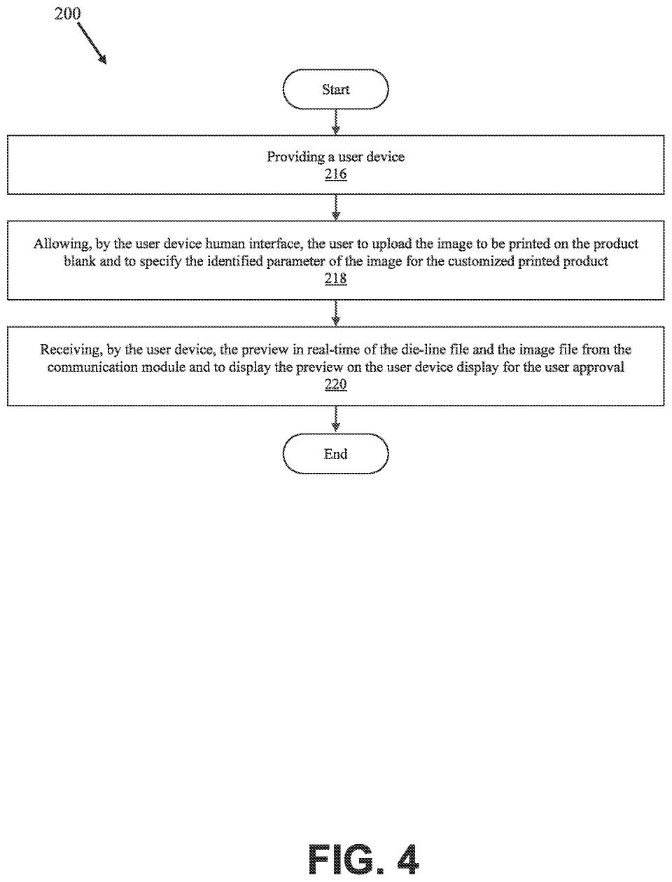

Referring now to FIG. 4, a flowchart is provided that describes additional steps to the computer-implemented method 200. In particular, the computer-implemented method 200 may further include a step 216 of providing a user device 140, as described herein. The computer-implemented method 200 may include a step 218 of allowing, by the user device human interface 144, the user to upload the image 101 to be printed on the product blank 103 and to specify the identified parameter 114 of the image 101 for the customized printed product 105. The computer-implemented method 200 may include a step 220 of receiving, by the user device 140, the preview 128 in real-time of the die-line file 116 and the image file 118 from the communication module 110 and to display the preview 128 on the user device display 143 for the user approval.

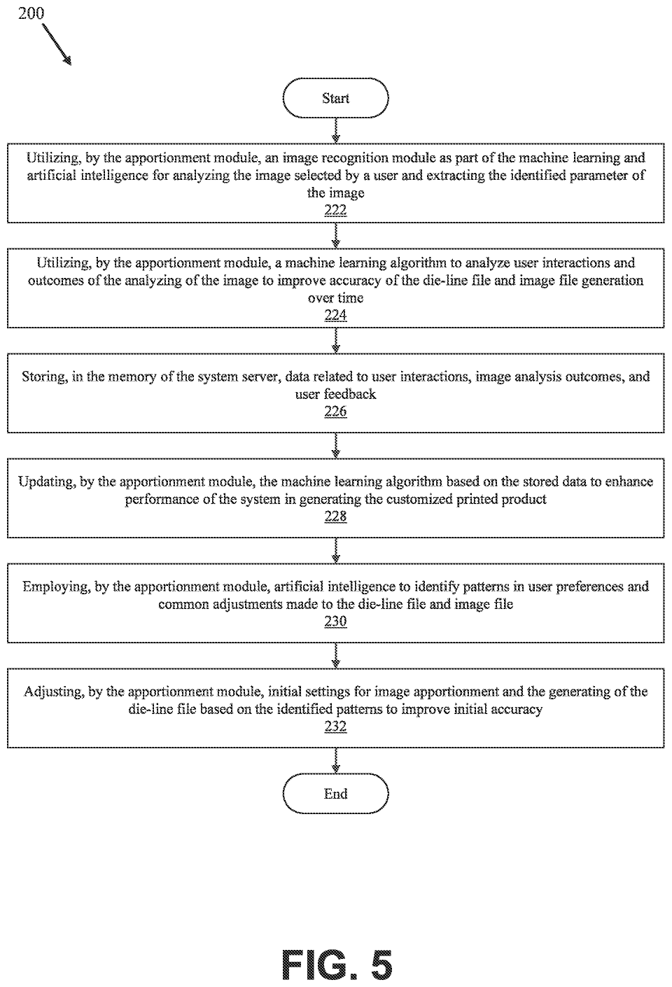

Referring now to FIG. 5, a flowchart is provided that further describes the computer-implemented method 200. The computer-implemented method 200 may include a step 222 of utilizing, by the apportionment module 112, an image recognition module as part of the machine learning and artificial intelligence for analyzing the image 101 selected by a user and extracting the identified parameter 114 of the image 101. The computer-implemented method 200 may include a step 224 of utilizing, by the apportionment module 112, a machine learning algorithm to analyze user interactions and outcomes of the analyzing of the image 101 to improve accuracy of the die-line file 116 and image file 118 generation over time. The computer-implemented method 200 may include a step 226 of storing, in the memory 106 of the system server 102, data related to user interactions, image analysis outcomes, and user feedback. The computer-implemented method 200 may include a step 228 of updating, by the apportionment module 112, the machine learning algorithm based on the stored data to enhance performance of the system in generating the customized printed product 105. The machine learning may utilize a feedback loop to incorporate user feedback into a learning process, thereby refining an ability of the system to apportion the image 101 and create the die-line file 116 and the image file 118 that align with an expectation of the user. The computer-implemented method 200 may also include a step 230 of employing, by the apportionment module 112, artificial intelligence to identify patterns in user preferences and common adjustments made to the die-line file 116 and image file 118. The computer-implemented method 200 may include a step 232 of adjusting, by the apportionment module 112, initial settings for image apportionment and the generating of the die-line file 116 based on the identified patterns to improve initial accuracy. The artificial intelligence may be configured to predict user preferences for crop types and image features based on historical data, thereby streamlining the manual selection for the user.

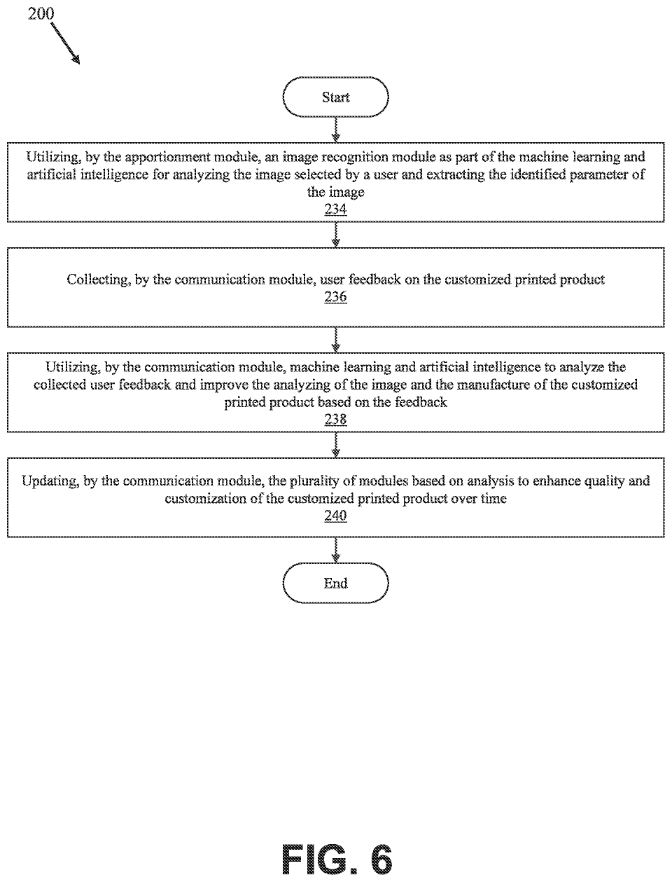

Referring now to FIG. 6, a flowchart is provided that further describes the computer-implemented method 200. The computer-implemented method 200 may include a step 234 of utilizing, by the apportionment module 112, an image recognition module as part of the machine learning and artificial intelligence for analyzing the image 101 selected by a user and extracting the identified parameter 114 of the image 101. The computer-implemented method 200 may include a step 236 of collecting, by the communication module 110, user feedback on the customized printed product 105. The computer-implemented method 200 may include a step 238 of utilizing, by the communication module 110, machine learning and artificial intelligence to analyze the collected user feedback and improve the analyzing of the image 101 and the manufacture of the customized printed product 105 based on the feedback. The computer-implemented method 200 may include a step 240 of updating, by the communication module 110, the plurality of modules 108 based on analysis to enhance quality and customization of the customized printed product 105 over time.

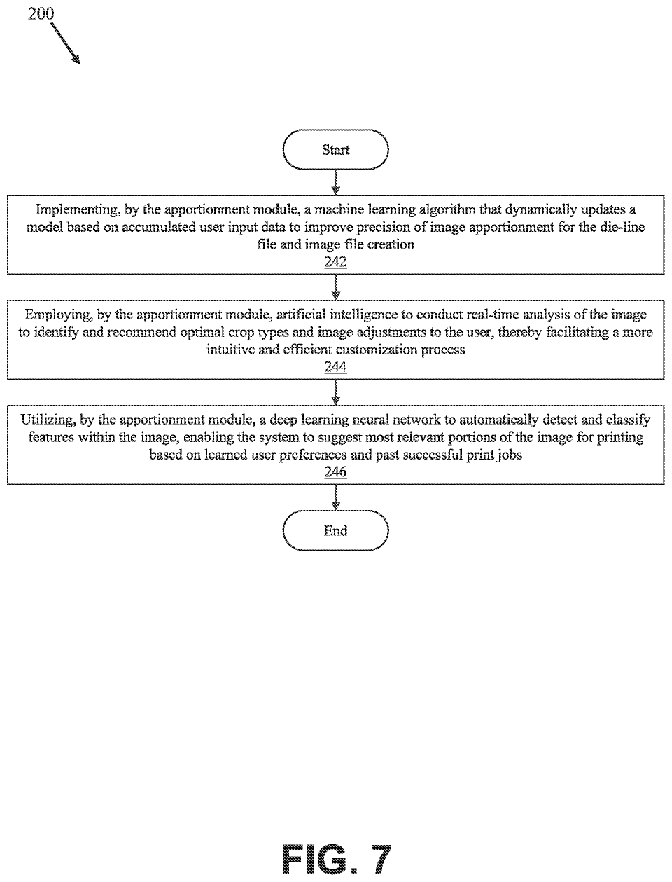

Referring now to FIG. 7, a flowchart is provided that further describes the computer-implemented method 200. The computer-implemented method 200 may include a step 242 of implementing, by the apportionment module 112, a machine learning algorithm that dynamically updates a model based on accumulated user input data to improve precision of image apportionment for the die-line file 116 and image file creation 118. The computer-implemented method 200 may include a step 244 of employing, by the apportionment module 112, artificial intelligence to conduct real-time analysis of the image 101 to identify and recommend optimal crop types and image adjustments to the user, thereby facilitating a more intuitive and efficient customization process. The computer-implemented method 200 may include a step 246 of utilizing, by the apportionment module 112, a deep learning neural network to automatically detect and classify features within the image 101, enabling the system to suggest most relevant portions of the image 101 for printing based on learned user preferences and past successful print jobs.

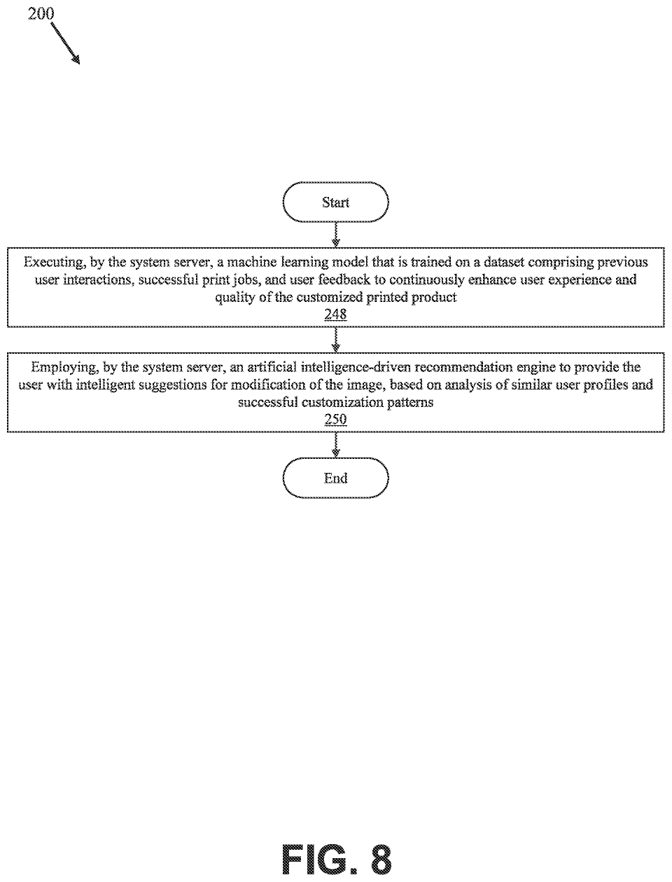

Referring now to FIG. 8, a flowchart is provided that further describes additional steps of the computer-implemented method 200. The computer-implemented method 200 may include a step 248 of executing, by the system server 102, a machine learning model that may be trained on a dataset comprising previous user interactions, successful print jobs, and user feedback to continuously enhance user experience and quality of the customized printed product 105. The computer-implemented method 200 may include a step 250 of employing, by the system server 102, an artificial intelligence-driven recommendation engine to provide the user with intelligent suggestions for modification of the image 101, based on analysis of similar user profiles and successful customization patterns.

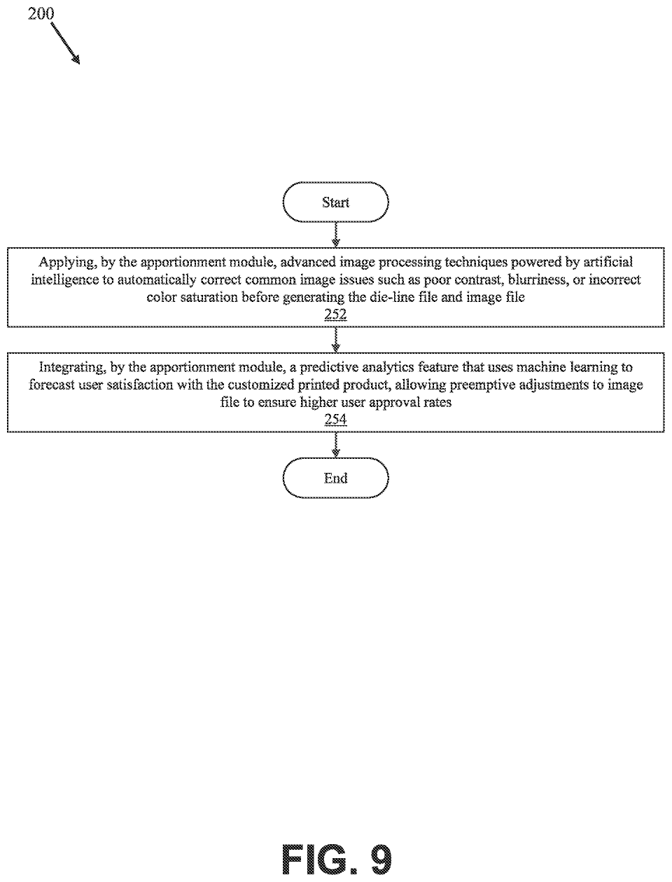

Referring now to FIG. 9, a flowchart is provided that further describes steps of the computer-implemented method 200. The computer-implemented method 200 may include a step 252 of applying, by the apportionment module 112, advanced image processing techniques powered by artificial intelligence to automatically correct common image issues such as poor contrast, blurriness, or incorrect color saturation before generating the die-line file 116 and image file 118. The computer-implemented method 200 may include a step 254 of integrating, by the apportionment module 112, a predictive analytics feature that uses machine learning to forecast user satisfaction with the customized printed product 105, allowing preemptive adjustments to the image file to ensure higher user approval rates.

It should also be appreciated that the computer-implemented method 200 may include additional steps, not shown. For example, the computer-implemented method 200 may include a step of generating, by the apportionment module 112, a plurality of available crop types or tiles based on the image 101 uploaded by the user, the user being provided with the preview, by the communication module 110, for each of the plurality of available crop types for the manual selection. The plurality of available crop types may be provided in the form of the mosaic, for example, as shown in FIGS. 14-16.

The computer-implemented method 200 may further include a step of receiving, by the communication module 110, audible or typewritten instructions. The audible or typewritten instructions may include specific commands for manufacturing the customized printed product 105. The step may include the system server 102 utilizing artificial intelligence to analyze the image 101, and generate a custom crop type based on the image 101 analyzed.

Following the aforementioned steps, a non-limiting example of the computer-implemented method resulting in the creation of the mosaic could involve a user uploading a selfie taken with two people. The apportionment module would then perform multiple segmentations simultaneously on this image. In one segmentation, the system would outline the two faces in tiles within the mosaic, providing a clear delineation of each individual's facial features. In another segmentation, it would outline two sets of faces with hair, capturing more of the individuals' appearances by including their hairstyles. In a further segmentation, the system would outline two sets of heads and necks, offering a more comprehensive representation that includes the upper portion of the subjects' bodies. All these tiles would be automatically generated and presented in the form of the mosaic for review and selection by the user. This allows the user to choose the preferred segmentation that best fits their desired outcome for the customized printed product, whether they are seeking a focus on facial features, a more complete portrayal with hair, or a broader depiction including the neck. The user can easily review the different segmentation options in the mosaic and select the one that aligns with their personal preference or the intended use of the printed product.

Another non-limiting example that would result in a mosaic being generated could involve a user uploading an image of their pet dog playing in a park. The apportionment module could execute multiple segmentations to create a variety of crop types. In one segmentation, the system might outline the dog's entire body in tiles, capturing the full figure of the pet amidst the park setting. In a second segmentation, it could focus on the dog's face, providing a close-up view that highlights the pet's facial expressions. A third segmentation might include the dog's face and the immediate surrounding area, such as a favorite toy or a distinctive collar, offering context to the pet's environment or personality. Each of these segmentations would be automatically arranged into a mosaic, allowing the user to visually compare the different perspectives of their pet. The user could then review the mosaic and select the segmentation that best captures the essence of their pet for the customized printed product. This could be particularly appealing for creating personalized items like pet tags, custom pet portraits, or even a series of stickers that celebrate the pet's character. The mosaic serves as a visual menu, providing the user with a creative and user-friendly way to make an informed choice for their custom print. One of ordinary skill in the art can select any suitable number and types of crop types or tiles to be automatically presented in the mosaic, as desired.

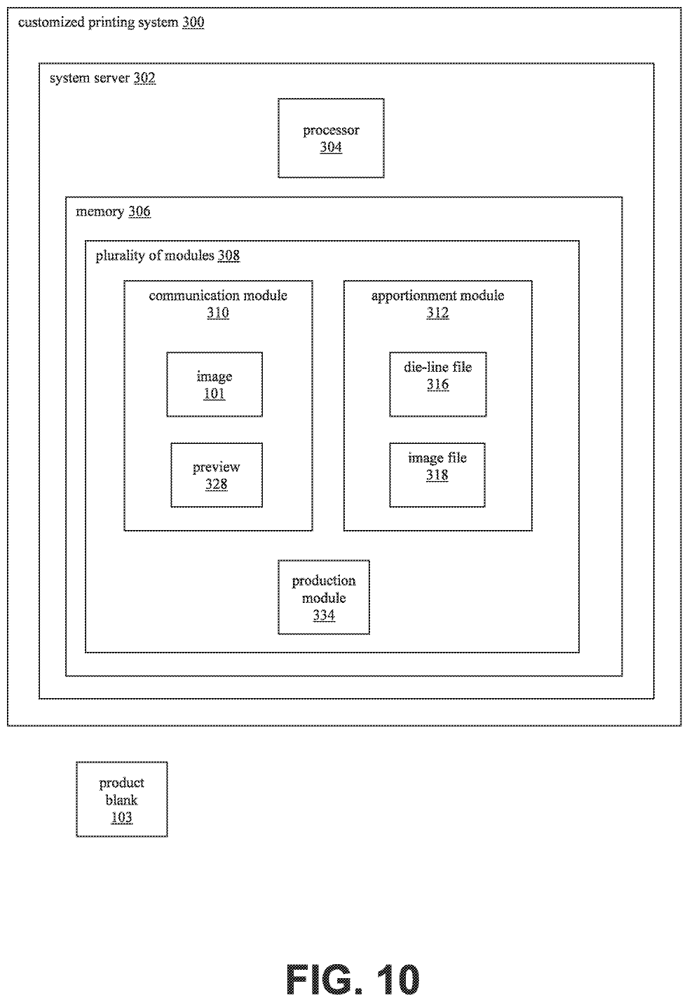

FIG. 10 is a block diagram that describes a customized printing system 300, according to a second embodiment of the present disclosure. The customized printing system 300 may include a system server 302. The system server 302 may include a processor 304 and a memory 306. The memory 306 may include a plurality of modules 308 storing tangible, non-transitory, processor executable instructions. The plurality of modules 308 may include an apportionment module 312 configured to utilize artificial intelligence to analyze an image 101 uploaded by a user and automatically generate a plurality of available crop types based on content of the image 101 and a communication module 310 configured to provide the user with a preview 328 of each of the available crop types for manual selection of a selected crop type from the plurality of available crop types for production of the customized printed product 105. Advantageously, the customized printing system 300 may allow for greater customization and uniqueness to the custom printed product based on the preference of the user. The customized printing system 300 provides multiple layers of customization of the image 101 for printing on a product blank 103.

Advantageously, the communication module 310 may generate every single available crop type for the user, without the need for the user to manually select the crop type or be constricted to a limited selection of crop types. The generation of the available crop types may be provided to the user as previews 328. The user may select the preview 328 to the preference of the user which may then allow the user to further customize the image 101 before transmitting to a production module 334, as described herein. The customization of the image 101 may include, but is not limited to, cropping the image 101, segmenting the image 101, overlaying a portion of the image 101 on another image 101′, combining the image 101 with another image 101′, overlaying custom text on a portion of the image 101, polishing a portion of the image 101 to remove obstructions, editing the quality of the image 101, and combinations thereof. One of ordinary skill in the art may select suitable customization options for the user within the scope of the present disclosure.

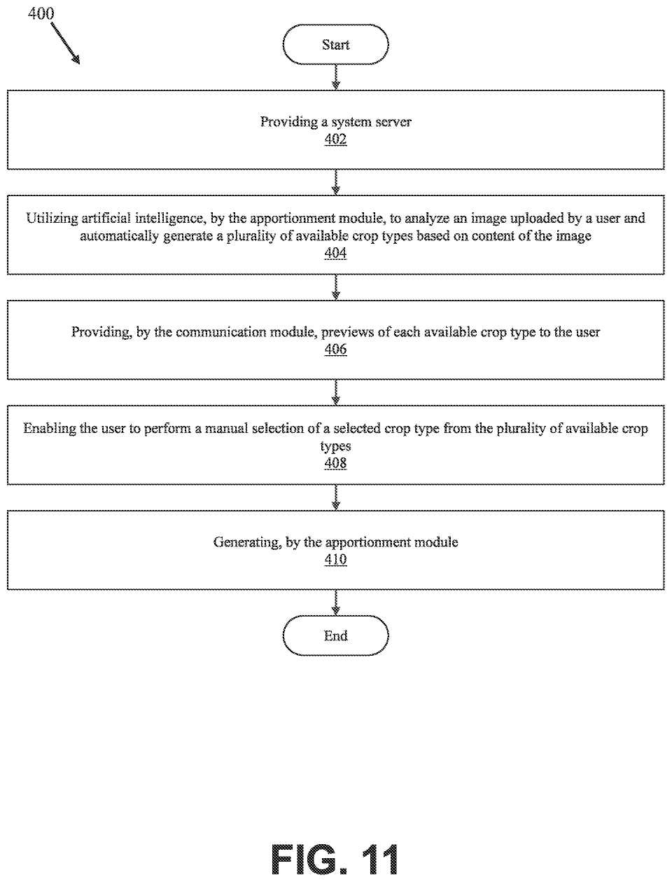

Referring now to FIG. 11, a flowchart is provided that describes a computer-implemented method 400 for manufacturing a customized printed product 105, using the customized printing system 300. The computer-implemented method may include a step 402 of providing a customized printing system 300 including a system server 302 as described herein. The computer-implemented method 400 may include a step 404 of utilizing artificial intelligence, by the apportionment module 312, to analyze an image 101 uploaded by a user and automatically generate a plurality of available crop types based on content of the image 101. The computer-implemented method 400 may include a step 406 of providing, by the communication module 310, previews of each available crop type to the user. The computer-implemented method 400 may include a step 408 of enabling the user to perform a manual selection of a selected crop type from the plurality of available crop types. The computer-implemented method 400 may include a step 410 of generating, by the apportionment module a die-line file 316 and an image file 318 based on the selected crop type for production of the customized printed product 105.

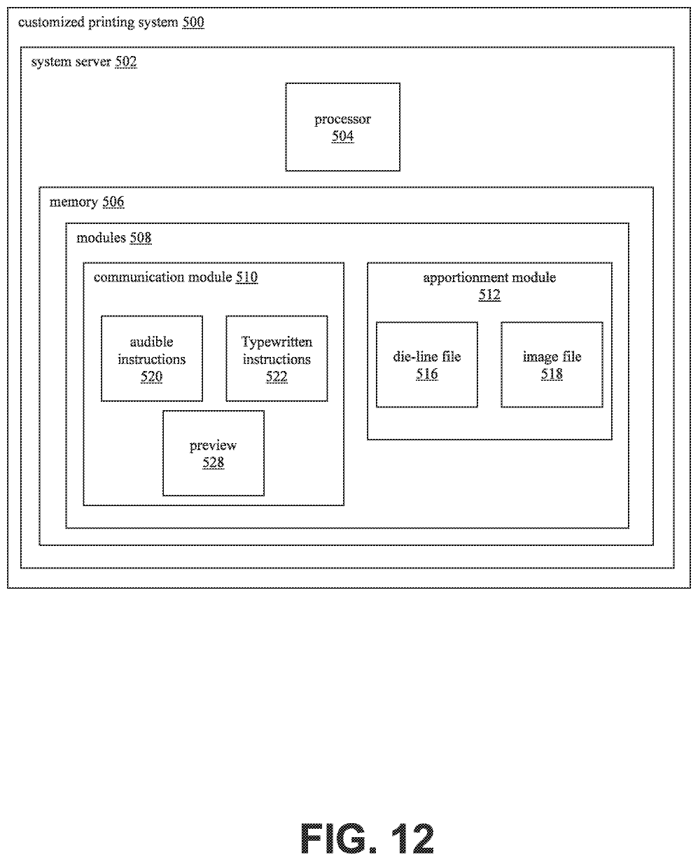

FIG. 12 is a block diagram that describes a customized printing system 500, according to a third embodiment of the present disclosure. In some embodiments, the customized printing system 500 may include a system server 502. The system server may include a processor 504 and a memory 506. The memory 506 may also include a plurality of modules 508 storing tangible, non-transitory, processor executable instructions. The plurality of modules 508 may include a communication module 510 and an apportionment module 512. The communication module 510 may include audible instructions 520 from a user as well as typewritten instructions 522 from the user. The audible instructions 520 and the typewritten instructions 522 each include specific commands for creating the customized printed product 105. The communication module 510 may be configured to provide a final product preview 528 for approval by the user. The apportionment module 512 may be configured to utilize artificial intelligence to analyze the image 101 in accordance with the audible instructions 520 or typewritten instructions 522, and further generate a custom crop type based on the audible or typewritten instructions 520, 522. The apportionment module 512 may also be configured to generate a die-line file 516 and an image file 518 for production of the customized printed product 105. The artificial intelligence may be configured to automatically apportion or crop the image 101 as indicated by the user in real-time. The customized printing system 500 may use these specific commands for creating the customized printed product 105, and may be configured to provide a final product preview for approval by the user. Advantageously, the customized printing system 500 creates the custom air freshener with minimal manual action by the user, and simply requires the user to approve the design based on the audible or electronic instructions received by the customized printing system 500.

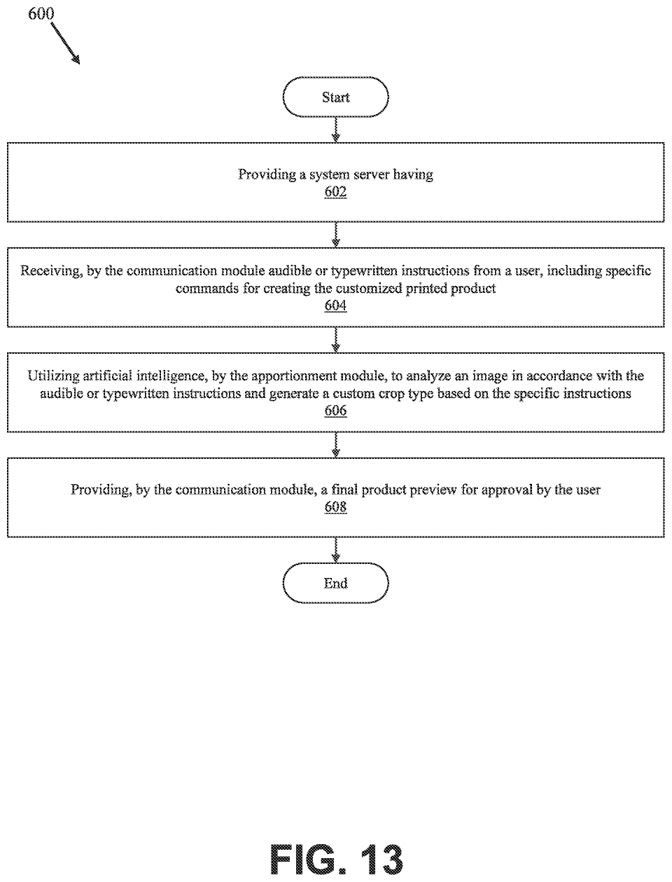

Referring now to FIG. 13, a flowchart is provided that describes a computer-implemented method 600 for manufacturing a customized printed product 105, using the customized printing system 500. The computer-implemented method 600 may include a step 602 of providing a customized printing system 500 having a system server 502 as described herein. The computer-implemented method 600 may include a step 604 of receiving, by the communication module 510 audible instructions 520 or typewritten instructions 522 from a user, including specific commands for creating the customized printed product 105. The computer-implemented method 600 may include a step 606 of utilizing artificial intelligence, by the apportionment module 512, to analyze an image 101 in accordance with the audible instructions 520 or typewritten instructions 522 and generate a custom crop type based on the specific instructions. The computer-implemented method 600 may include a step 608 of providing, by the communication module 510, a final product preview 528 for approval by the user.

Advantageously, the customized printing system 100, 300, 500 provides an easy and effective system that may print and cut customized images onto a product to form a printed product. The customized printing system 100, 300, 500 reduces the need for multiple systems to create a customized printed product 105. Desirably, the customized printing system 100, 300, 500 may print individual two-dimensional images on objects within a unitary system that may either be comprised of a unitary machine or multiple machines working in conjunction with one another.

Further advantageously, the preview allows the user to modify the project to militate against mistakes in the final printed product. The customized printed product 105, such as an air freshener, can be customized to include various scents, shapes, and additional features such as string holes for hanging. The customized system 100, 300, 500 provides a user-friendly platform for creating personalized items that reflect individual preferences or brand identities. This innovative approach streamlines the production process, allowing for rapid prototyping and on-demand manufacturing, which is particularly beneficial for small businesses or bespoke item creators. The system's flexibility in handling different materials and complex designs opens up new possibilities for product customization, from promotional merchandise to unique gifts. Additionally, the integration of machine learning and artificial intelligence ensures that the system continuously improves its performance, leading to higher quality products and enhanced user satisfaction. By simplifying the customization process, the system also democratizes access to personalized printing, making it accessible to a wider audience without the need for specialized design or technical skills.

### EXAMPLES

Example embodiments of the present technology are provided with reference to at least the FIGS. 14-29 enclosed herewith.

Overall, the user may upload an image to place on the product blank. The user may either crop the image manually, or the user may select a crop type of the image. More specifically, the crop type is compiled by the customized printing system 100 and is limited to cropping the image of either a person's head without hair, a person's head with hair, a pet head, or a car, as particular non-limiting examples. Once selected, a preview may be generated which allows the user to either approve or to regenerate the preview to the preference of the user. If the user approves the preview, the user may then select a position for the string hole, to allow a string to be placed through the string hole of the final printed product and to allow the user to hang the customized air freshener. Once the design is finalized, the customized printing system 100 may transmit the approved design to the production module for printing and cutting out the customized printed product.

### Example 1: Customized Printing System 100 of First Embodiment

The user may utilize the customized printing system 100 to create a custom air freshener. In this embodiment, the communication module may be configured to provide a set of crop types for the user to select. Specifically, the set of crop types may include, but are not limited to, cropping one of a pet head, a face, a face with hair, or a car. Other types of crop types may also be employed within the scope of the present disclosure. The crop types may be selected from a drop-down list. The user may select the type of crop type from the drop-down list to allow the communication module to provide the preview of the identified parameter, which may be manipulated by the user. The communication module may utilize artificial intelligence to segment the image based on the selected crop type and generate the identified parameter. The identified parameter may be related to the selected crop type. Ultimately, the generation of the identified parameter may be transmitted to the apportionment module, which may further generate the preview of the die-line file and the image file to transmit to the production module.

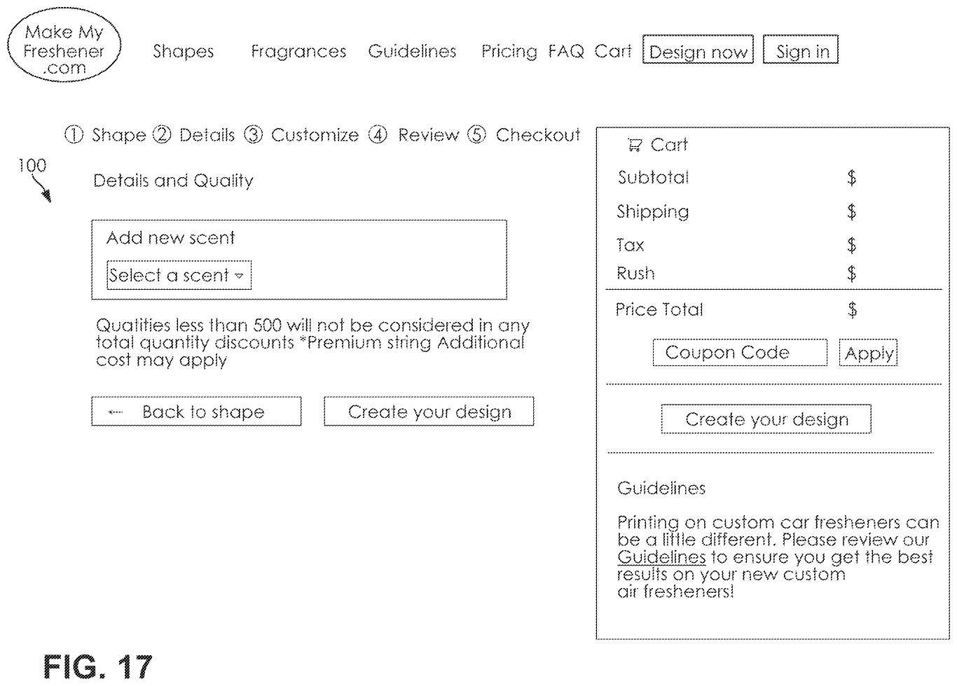

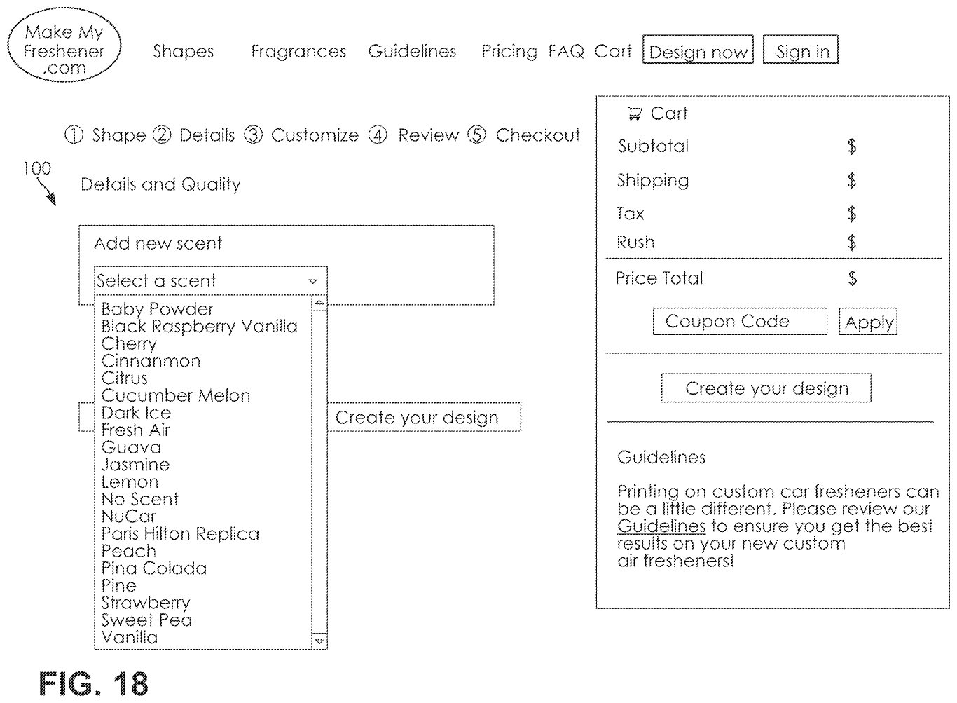

As shown in FIGS. 14-29, the user may either select the option to create a custom shape using artificial intelligence, or the user may select from a plurality of crop types. The plurality of crop types, as illustrated in FIGS. 14-16, include, but are not limited to, a rectangle in portrait, a rectangle in landscape, a round shape, an oval in portrait, an oval in landscape, a square, a shield, a tombstone, a house, a car, a cloud, a diamond, a football, and more. One of ordinary skill in the art may select suitable shapes within the scope of the present disclosure. In this example, the user may select the custom shape using artificial intelligence, as a non-limiting example. Once the user selects the shape to their preference, they may be directed to pick a particular scent for the air freshener, as shown in FIG. 17. The air freshener may be provided in a variety of different scents, including, but not limited to, baby powder, black raspberry vanilla, cherry, cinnamon, citrus, guava, lemon, peach, pine, and many more. The user may also choose to select no scent. The scents may be provided via a drop-down list which requires the user to select a scent from the list of options, as shown in FIG. 18. One of ordinary skill in the art may select suitable scents within the scope of the present disclosure.

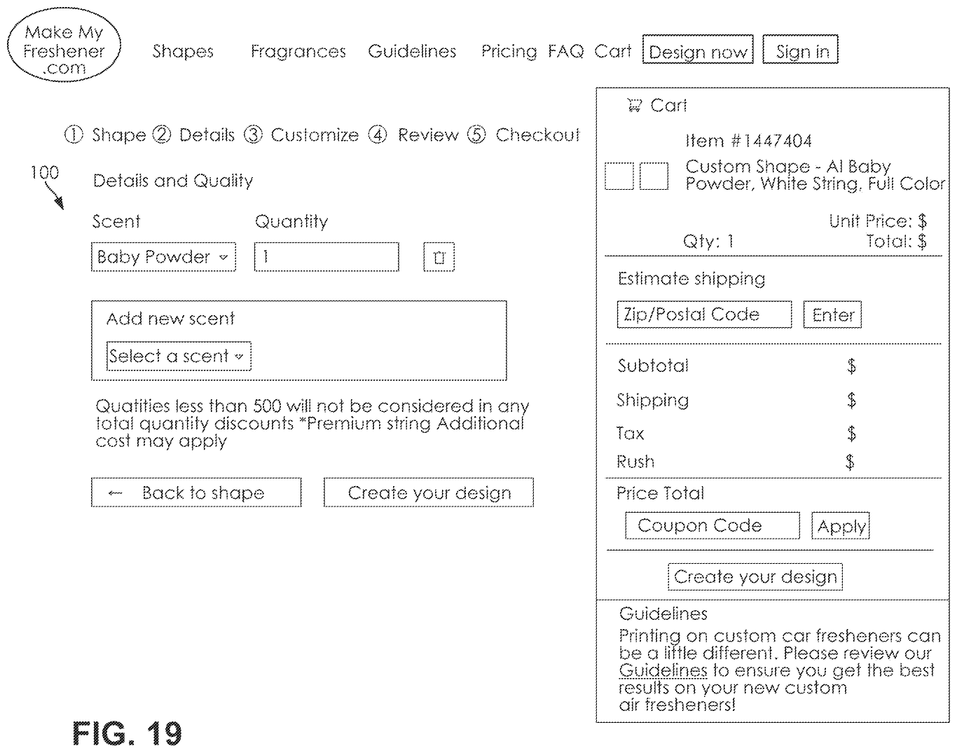

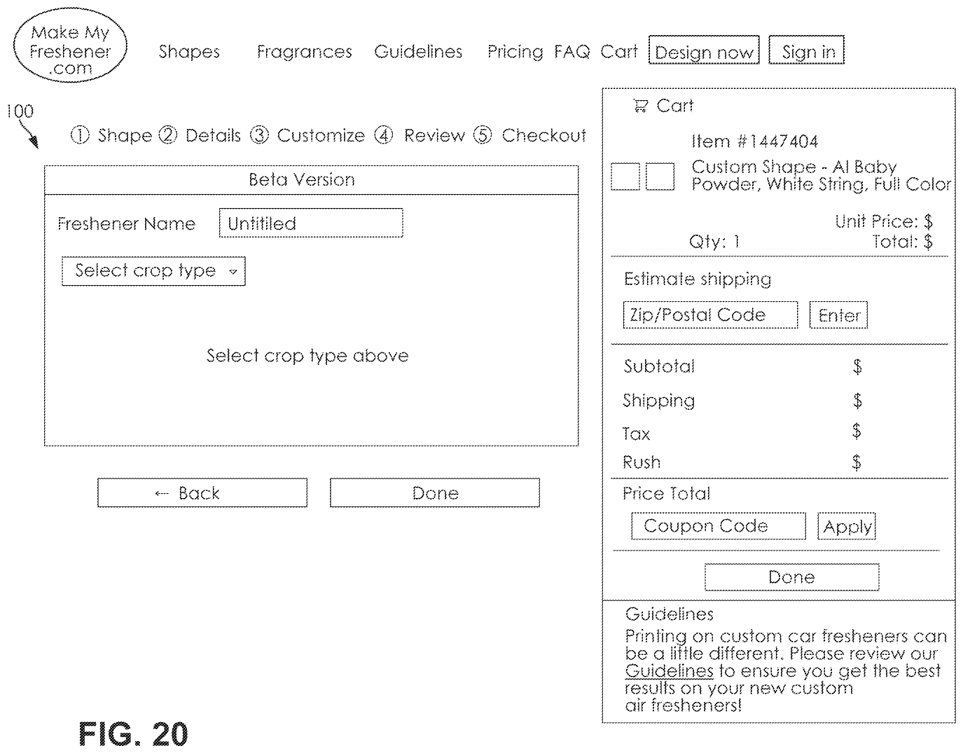

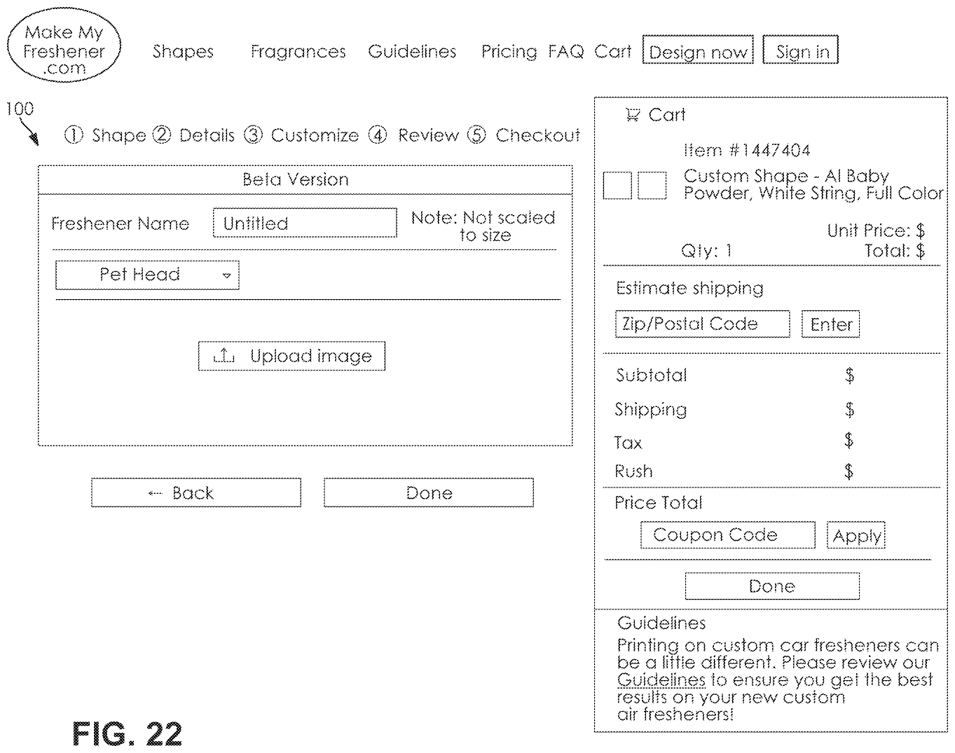

The user may also select a quantity of air fresheners for each scent selected, as shown in FIG. 19. The user may also add different scents for each quantity of air fresheners created. As specifically shown in FIG. 19, the user may select Baby Powder as the scent with a single quantity for the custom air freshener, as a non-limiting example. Once the user selects the scent and quantity, the user may be directed to select a crop type, as shown in FIG. 20. The crop type may be provided via another drop-down list. The drop-down list may include the option to crop the pet head and body, a face, a face with hair, or a car. One of ordinary skill in the art may select suitable crop types to limit the cropping of the image within the scope of the present disclosure. The user may also be given the option to title the project. As shown in FIG. 8, the user may title the project as “Project 1” and may select “Pet Head” as the crop type, as a non-limiting example. Once the user selects the crop type, the user may be directed to upload the image, as shown in FIG. 22.

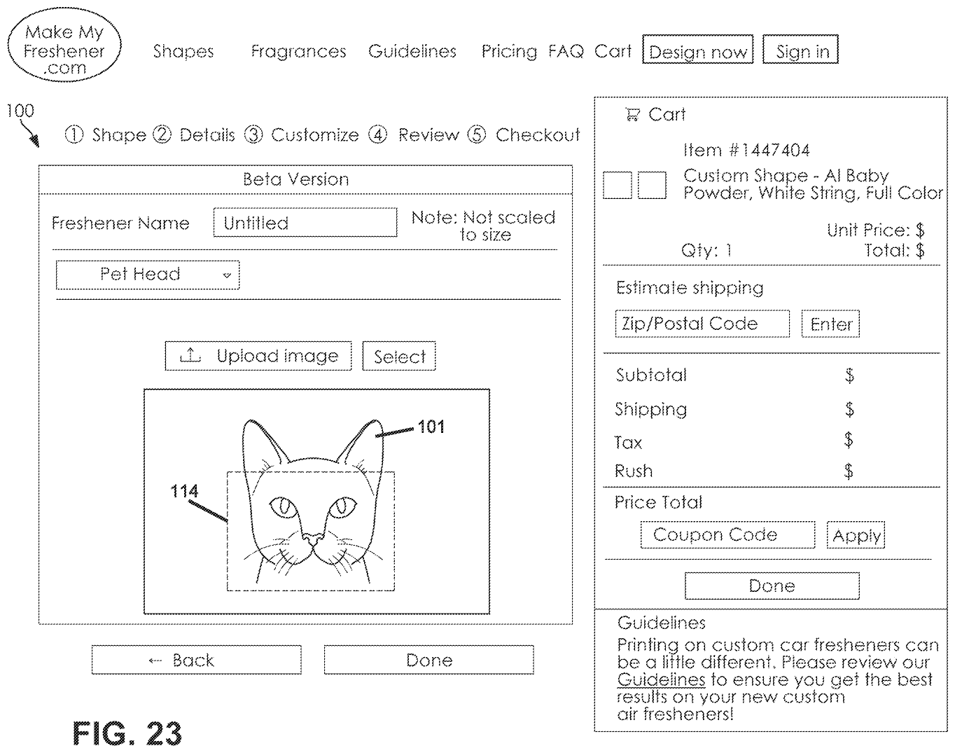

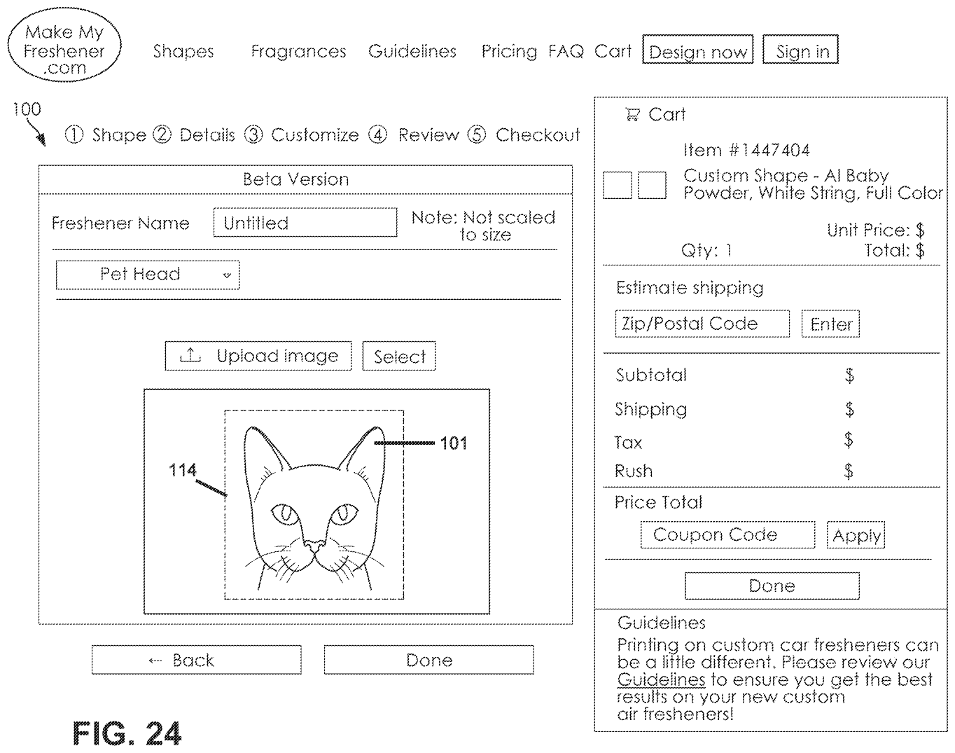

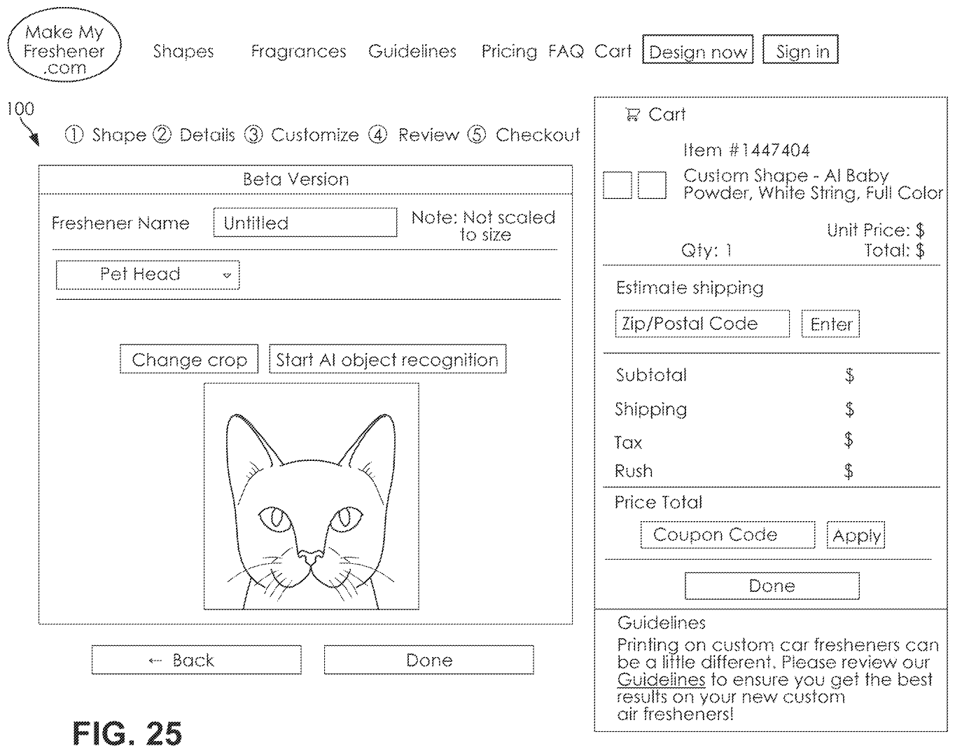

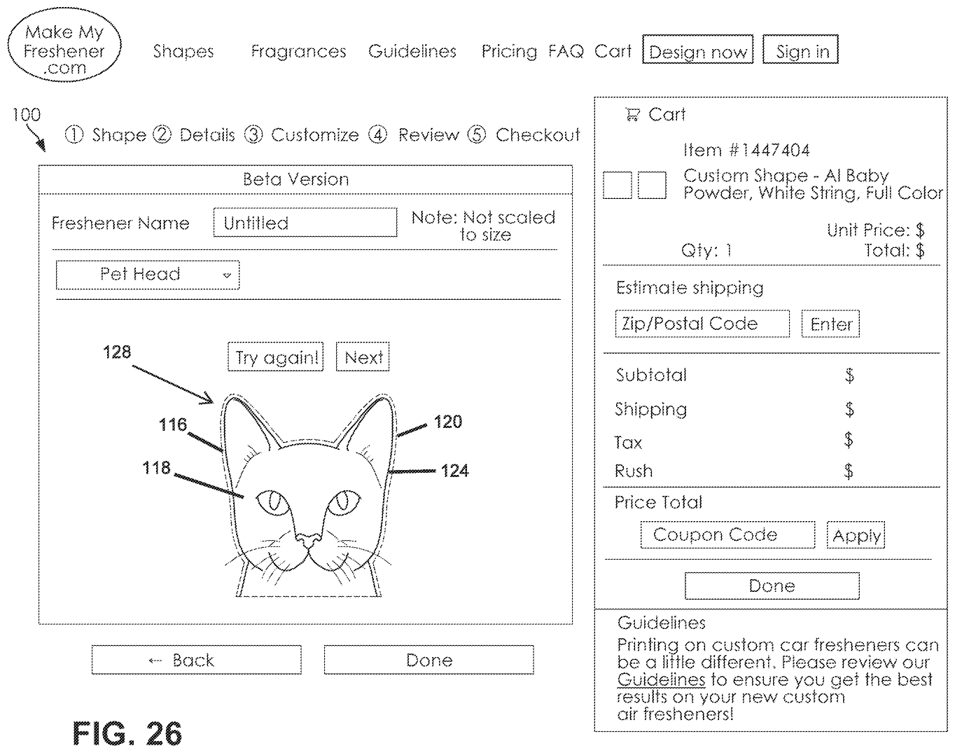

The user may upload the image, as explained herein, the image may be in any file format. As shown in FIG. 23, the user may upload a picture of a cat. With reference to FIG. 23, an identified parameter may be displayed around the face of the cat, per the selected crop type. This identified parameter may be displayed via dotted lines. The user may manipulate the identified parameter to the preference of the user. More specifically, the user may move the identified parameter to more accurately encompass the head of the cat, per the user's preference. As shown in FIG. 24, the identified parameter may be manipulated to include the ears of the cat. The user may be given the option to change the crop or may start the artificial intelligence recognition tool. Once the user approves the crop type and the selected identified parameter, the user may select the option to “Start AI Object Recognition”, as shown in FIG. 25. This allows the apportionment module of the customized printing system 100 to generate the die-line file and the image file, and generate a preview, in real-time, of the custom air freshener before transmitting to the production module. If the user approves of the preview, the user may click “Done” as shown in FIG. 26. If the user does not approve of the preview and would like to further manipulate and change the custom air freshener, the user may click “Back”.

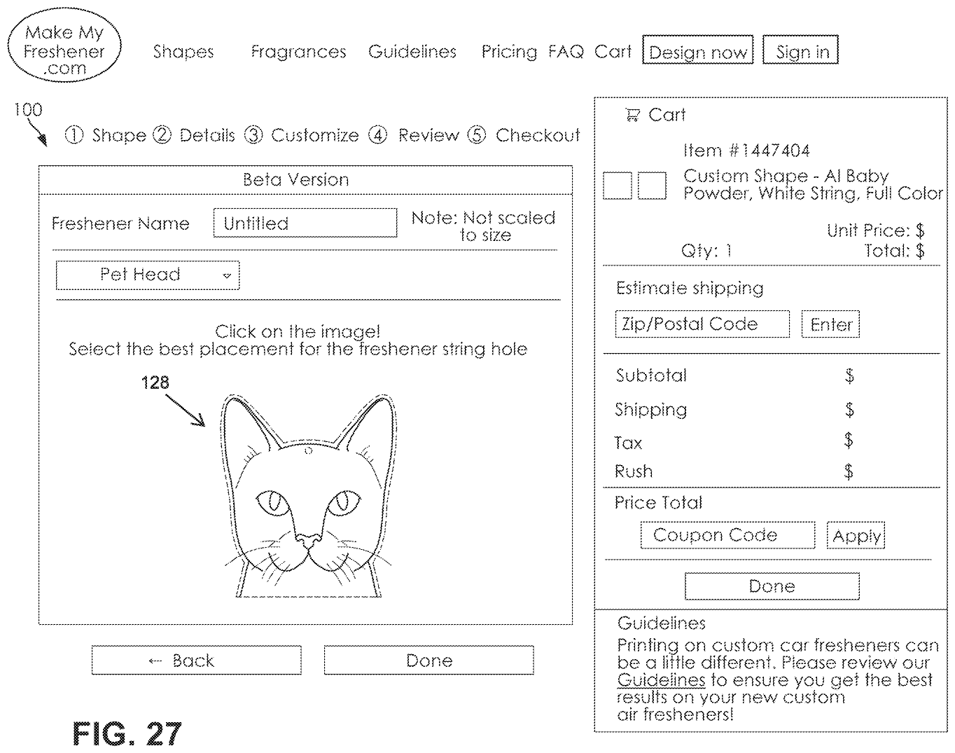

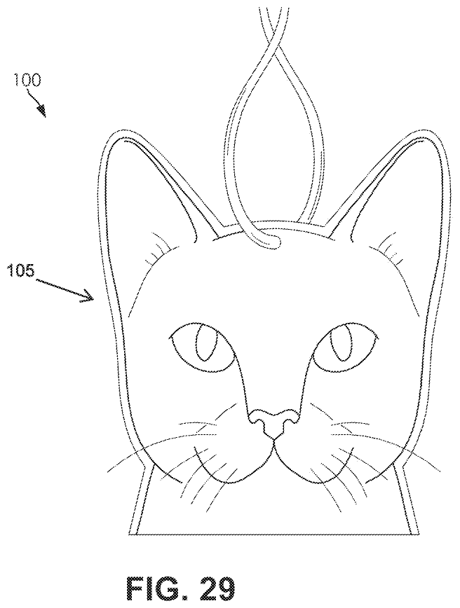

As shown in FIG. 27, the user is provided the option to select where to place the string hole. This allows the user to place the string hole anywhere on the preview by simply clicking on the desired location. Finally, the user can approve the custom air freshener which transmits the approved die-line file and the approved image file to the production module for printing and cutting. Advantageously, the customized printing system 100 may provide a summary of the order on the same page for the user to follow along with. Further, the production module provides a custom air freshener of a cat's head with a string hole, as shown in FIG. 29. The custom air freshener has the unique shape of the cat's head with the ears, directly corresponding to the shape of the cat from the uploaded image.

In another embodiment, the user may select one of the pre-selected crop type of the plurality of crop types, specifically shown in FIGS. 14-16, such as a rectangle in portrait to create the custom air freshener. If selected, the user may be directed to a separate page to upload the image, per the preference of the user, and the user may customize the rectangular-shaped air freshener. The user may customize the air freshener which includes, but is not limited to, adding text, changing the brightness and contrast of the image, as well as adding another image. One of ordinary skill in the art may select suitable customization options within the scope of the present disclosure. Once the user finalizes the customization of the air freshener and the design, the user may approve of the design, which allows the apportionment module to transmit the final design to the production module, as described herein.

### Example 2: Customized Printing System 300 of Second Embodiment

The user may utilize the customized printing system 300 to create a custom air freshener. In this embodiment, a user may upload a picture for the custom air freshener using the communication module displayed via the user's smartphone. As a non-limiting example, the user may upload a picture of a cat and its owner. The customized printing system 300 utilizes artificial intelligence to automatically analyze the image uploaded by the user and generate a plurality of available crop types based on that image. More specifically, the communication module, displayed via the user interface, will show the user several available crop types of the cat and/or its owner. As a non-limiting example, the plurality of available crop types may include, but are not limited to, the head of the cat without its ears, the head of the cat with its ears, the head of the owner without hair, the head of the owner with hair, both the head of the cat and the head of the owner, the head and body of the cat, the head and body of the owner, both the entirety of the cat and the owner, and combinations thereof. Advantageously, the customized printing system provides every possibility and every available crop type based on the content of the image uploaded by the user and analyzed by the customized printing system. The user is given the opportunity to preview each of these available crop types. Further, the user is not limited to a particular selection of crop types.

Once the user selects the particular crop type to the preference of the user, the user may either be prompted to finalize the design or may further customize this selection. The customization of the image may include, but is not limited to, cropping the image, segmenting the image, overlaying a portion of the image on another image, combining the image with another image, overlaying custom text on a portion of the image, polishing a portion of the image to remove obstructions, editing the quality of the image, and combinations thereof. In a non-limiting example, the user may customize the uploaded image of the cat and its owner by removing any obstructions on the face of the owner, adjusting the brightness of the image, as well as adding customized text on a portion of the image. Once the user is satisfied with the design, the user may select a particular scent for the custom air freshener, a quantity of the custom air freshener, as well as the specific location of the string hole on the custom air freshener.

### Example 3: Customized Printing System 500 of Third Embodiment

The user may utilize the customized printing system 500 to create a custom air freshener. In this embodiment, the user may audibly recite instructions to the communication module via the user interface. Alternatively, the user may electronically type instructions to the communication module via the user interface. The user interface may be displayed via the user's mobile device. As a non-limiting example, the user may audibly recite via the user interface that the user would like a custom air freshener of the head of the cat with its ears and to place the string hole on the top center of the cat head, and the user may upload the image of the cat. The communication module takes the audible instructions and communicates the audible instructions to the apportionment module.

The apportionment module utilizes artificial intelligence to analyze the image uploaded by the user, and automatically generates the preview of the custom air freshener by cropping the head of the cat with its ears. The artificial intelligence further automatically generates the location of the string hole on the preview of the custom air freshener for the user to approve. The user is shown, via the user interface, the final design for approval. The user may further customize the design, as explained herein. Otherwise, once approved, the customized printing system may transmit the final design to the production module for printing and cutting out the custom air freshener of the cat's head with its ears.

### Use Cases

Although the systems and methods described herein relate to custom air fresheners, it should be appreciated that the customized printing system 100, 300, 500, and the methods 200, 400, 600 may be directed towards other products as described herein.

### Example 4: Personalized Air Fresheners for Pet Owners

An individual who is a pet owner and who wants to create personalized air fresheners featuring her dog. Using the customized printing system, she uploads her favorite photo of her dog using the user interface and selects just his smiling face for the product. The customized printing system's apportionment module automatically generates a die-line file that outlines the dog's face and an image file of the dog's face for printing. The individual may preview the custom shape and image in real time. Based on the individual's preference, the individual may make a few adjustments to improve the design and/or otherwise approve the design for transmitting to the production module. The production module may print and cut the air fresheners, and within a short time, the individual receives her personalized products, ready to distribute to family and friends as unique keepsakes.

### Example 5: Custom Stickers for Small Businesses

Another individual may run a small coffee shop and want to offer custom stickers with his logo as a giveaway to loyal customers. He uses the customized printing system to upload his shop's logo and specifies the exact size and shape he needs for the stickers. The customized printing system uses artificial intelligence and machine learning to quickly process his request, creating a precise die-line and image file that perfectly captures the essence of his brand. The individual can see a preview of the final sticker on his laptop, confirm the design, and send it off for production. The integrated printer and cutter produce the stickers with sharp detail and accuracy, enhancing his brand's visibility and customer engagement. The production module may also print a large quantity of custom stickers at a time, optimizing efficiency of the custom printing system.

### Example 6: Event Badges for Conferences

A person organizing a tech conference may need to create unique event badges for attendees. The user decides to use the customized printing system to design badges that feature a QR code and the attendee's photo. After uploading the necessary images and data, the customized printing system uses the apportionment module to generate the best layout for the badges and generate a plurality of different previews to choose from. The customized printing system may provide a real-time preview of each of these options, which allows the user to see exactly how the badges will look. Once the user approves the design, the production module efficiently prints and cuts the badges, which are then ready for distribution at the conference registration desk.

### Example 7: Personalized Decals for Car Enthusiasts

A car enthusiast may want to create custom decals of his vintage car collection to sell at auto shows. He selects high-quality photos of his cars and uploads them to the customized printing system. The AI-driven apportionment module helps him crop each image to focus on the cars' distinctive features. The user then uses the real-time preview to adjust the size and shape of each decal, ensuring they will fit perfectly on various car windows and bumpers. Once satisfied with the designs, the customized printing system may send the approved die-line file and image file to the production module, where they are printed with precision-cut, resulting in professional-grade decals.

### Example 8: Custom Iron-on Patches for DIY Crafters

Another individual may be a DIY crafter who loves to create custom clothing and accessories. The individual decides to make iron-on patches using the customized printing system. The individual may upload her hand-drawn designs and use the system to select the parts of the drawings she specifically wants to feature on the patches. The customized printing system may use the communication module to generate different options for each patch shape and different previews of the artwork on the patches. The apportionment module further processes the artwork, creating the die-line file and the image file for each patch shape. The individual may customize the colors and sizes using the real-time preview feature, ensuring that each patch will look perfect when ironed onto her creations. The individual may also overlay different text or images on the artwork to further customize the artwork. For example, the individual may place her name on the bottom of the artwork which will be placed overtop the artwork for final printing. After finalizing the designs, the production module prints and cuts the patches.

### Example 9: Efficient Custom Air Fresheners in Short Time

A user may want to quickly create an air freshener without the need to manually customize or enter any commands in the customized printing system. The user may upload a picture of his significant other to create an air freshener of the significant other's face. The user may audibly enter instructions to make the air freshener of the significant other's face including their hair. The customized printing system may input these instructions into the system and may analyze the picture uploaded by the user. The customized printing system may further automatically generate the die-line file and the image file using the system's artificial intelligence to create a preview of the air freshener. The user may approve the preview which may transmit the approval to the production module with little to no manual commands by the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A computer-implemented method for manufacturing a customized printed product, the method comprising steps of:
providing a system server having a processor and a memory on which a plurality of modules including tangible, non-transitory, processor executable instructions are stored,
the plurality of modules including a communication module and an apportionment module,
the communication module configured to receive an image to be printed on a product blank and an identified parameter of the image for the customized printed product, and
the apportionment module configured to determine a die-line file and an image file to be printed on the product blank, the die-line file defining a die-line perimeter and a die-line file surface area, and the image file defining an image file perimeter and an image file surface area, the die-line file surface area being greater than the image file surface area,
wherein the communication module is configured to create a preview of the die-line file and the image file, in real-time, and transmit the die-line file and the image file, the preview including a superimposition of the image file surface area on the die-line file surface area such that the image file perimeter is bounded entirely by the die-line perimeter and a border is defined as an area between the image file perimeter and the die-line perimeter, and
wherein the apportionment module is configured to utilize at least one of manual selection, machine learning, and artificial intelligence to apportion the image to generate the image file and the die-line file;
receiving, by the communication module, the image to be printed on the product blank and the identified parameter of the image for the customized printed product;
determining, by the apportionment module, the die-line file and the image file for the product blank based on the image received and the identified parameter; and
displaying, by the communication module, the preview in real-time of the die-line file and the image file to a user for production of the customized printed product.

2. The method of claim 1, further comprising a step of receiving, by the communication module, the manual selection of a crop type from a user, the crop type defining the identified parameter and a shape to make the customized printed product.

3. The method of claim 1, wherein the plurality of modules includes a production module, and the method further includes steps of:
transmitting, by the communication module, the die-line file and the image file to the production module upon user approval to manufacture the customized printed product;
printing, by a printer in communication with the production module, the image on an outer surface of the product blank in dependence on the image file; and
cutting, by a cutter in communication with the production module, a shape out of the product blank in dependence on the die-line file to form the customized printed product.

4. The method of claim 1, further comprising a step of scaling, by the apportionment module, the die-line perimeter and the image file perimeter relative to the product blank for production and printing, and wherein a shape of the die-line perimeter is same as but scaled relative to a shape of the image file perimeter.

5. The method of claim 1, further comprising steps of:
providing a user device having a user device processor, a user device memory, and at least one of a user device display and a user device human interface, the user device in communication with the communication module of the system server via a wide area network, and the at least one of the user device display and the user device human interface configured to permit the user to interact with the communication module,
wherein the user device processor executes instructions stored on the user device memory to facilitate the interaction between the user and the communication module.

6. The method of claim 5, further comprising a step of allowing, by the user device human interface, the user to upload the image to be printed on the product blank and to specify the identified parameter of the image for the customized printed product.

7. The method of claim 5, further comprising a step of receiving, by the user device, the preview in real-time of the die-line file and the image file from the communication module and to display the preview on the user device display for approval of the user.

8. The method of claim 1, further comprising a step of utilizing, by the apportionment module, an image recognition module as part of the machine learning and artificial intelligence for analyzing the image selected by a user and extracting the identified parameter of the image.

9. The method of claim 8, further comprising steps of:
utilizing, by the apportionment module, a machine learning algorithm to analyze user interactions and outcomes of the analyzing of the image to improve accuracy of the die-line file and image file generation over time;
storing, in the memory of the system server, data related to user interactions, image analysis outcomes, and user feedback; and
updating, by the apportionment module, the machine learning algorithm based on the stored data to enhance performance of the system in generating the customized printed product.

10. The method of claim 9, wherein the machine learning utilizes a feedback loop to incorporate user feedback into a learning process, thereby refining an ability of the system to apportion the image and create the die-line file and the image file that align with an expectation of the user.

11. The method of claim 8, further comprising steps of:
collecting, by the communication module, user feedback on the customized printed product;
utilizing, by the communication module, machine learning and artificial intelligence to analyze the collected user feedback and improve the analyzing of the image and the manufacture of the customized printed product based on the feedback; and
updating, by the communication module, the plurality of modules based on analysis to enhance quality and customization of the customized printed product over time.

12. The method of claim 10, further comprising steps of:
employing, by the apportionment module, artificial intelligence to identify patterns in user preferences and common adjustments made to the die-line file and image file; and
adjusting, by the apportionment module, initial settings for image apportionment and the generating of the die-line file based on the identified patterns to improve initial accuracy.

13. The method of claim 12, wherein the artificial intelligence is configured to predict user preferences for crop types and image features based on historical data, thereby streamlining the manual selection for the user.

14. The method of claim 1, further comprising steps of:
implementing, by the apportionment module, a machine learning algorithm that dynamically updates a model based on accumulated user input data to improve precision of image apportionment for the die-line file and image file creation;
employing, by the apportionment module, artificial intelligence to conduct real-time analysis of the image to identify and recommend optimal crop types and image adjustments to the user, thereby facilitating a more intuitive and efficient customization process; and
utilizing, by the apportionment module, a deep learning neural network to automatically detect and classify features within the image, enabling the system to suggest most relevant portions of the image for printing based on learned user preferences and past successful print jobs.

15. The method of claim 1, further comprising steps of:
executing, by the system server, a machine learning model that is trained on a dataset comprising previous user interactions, successful print jobs, and user feedback to continuously enhance user experience and quality of the customized printed product; and
employing, by the system server, an artificial intelligence-driven recommendation engine to provide the user with intelligent suggestions for modification of the image, based on analysis of similar user profiles and successful customization patterns.

16. The method of claim 1, further comprising steps of:
applying, by the apportionment module, advanced image processing techniques powered by artificial intelligence to automatically correct common image issues such as poor contrast, blurriness, or incorrect color saturation before generating the die-line file and image file;
integrating, by the apportionment module, a predictive analytics feature that uses machine learning to forecast user satisfaction with the customized printed product, allowing preemptive adjustments to the image file to ensure higher user approval rates.

17. The method of claim 3, further comprising steps of:
leveraging, by the system server, an artificial intelligence module that utilizes machine learning to adaptively learn from each customization process, thereby improving system performance and user satisfaction over time; and
employing, by the system server, a self-optimizing machine learning framework that autonomously adjusts parameters for image analysis and die-line file generation to minimize manual user intervention and maximize efficiency of the production module.

18. The method of claim 1, further comprising a step of generating, by the apportionment module, a plurality of available crop types based on the image uploaded by the user, the user being provided with the preview, by the communication module, for each of the plurality of available crop types for the manual selection.

19. The method of claim 1, further comprising a step of receiving, by the communication module, audible or typewritten instructions including specific commands for manufacturing the customized printed product, the system server utilizing artificial intelligence to analyze the image, and generate a custom crop type based on the image analyzed.

20. The customized printed product manufactured according to the method of claim 1.

21. A system for creating a customized printed product, comprising:
a system server having a processor and a memory on which a plurality of modules including tangible, non-transitory, processor executable instructions are stored,
the plurality of modules including a communication module and an apportionment module,
the communication module configured to receive an image to be printed on a product blank and an identified parameter of the image for the customized printed product, and
the apportionment module configured to determine a die-line file and an image file to be printed on the product blank, the die-line file defining a die-line perimeter and a die-line file surface area, and the image file defining an image file perimeter and an image file surface area, the die-line file surface area being greater than the image file surface area,
wherein the communication module is configured to create a preview of the die-line file and the image file, in real-time, and transmit the die-line file and the image file, the preview including a superimposition of the image file surface area on the die-line file surface area such that the image file perimeter is bounded entirely by the die-line perimeter and a border is defined as an area between the image file perimeter and the die-line perimeter, and
wherein the apportionment module is configured to utilize at least one of manual selection, machine learning, and artificial intelligence to apportion the image to generate the image file and the die-line file;
the system server configured to:
receive, by the communication module, the image to be printed on the product blank and the identified parameter of the image for the customized printed product;
determine, by the apportionment module, the die-line file and the image file for the product blank based on the image received and the identified parameter; and
display, by the communication module, the preview in real-time of the die-line file and the image file to a user for production of the customized printed product.

22. The system of claim 21, wherein the plurality of modules includes a production module, the communication module configured to transmit the die-line file and the image file to the production module upon user approval to manufacture the customized printed product, and wherein the system further includes:
a printer in communication with the production module and configured to print the image on an outer surface of the product blank in dependence on the image file; and
a cutter in communication with the production module and configured to cut a shape out of the product blank in dependence on the die-line file to form the customized printed product.

23. The system of claim 21, further comprising:
a user device having a user device processor, a user device memory, and at least one of a user device display and a user device human interface,
the user device in communication with the communication module of the system server via a wide area network,
the at least one of the user device display and the user device human interface configured to permit the user to interact with the communication module,
wherein the user device processor executes instructions stored on the user device memory to facilitate the interaction between the user and the communication module.

24. The system of claim 23, wherein the user device human interface includes at least one of a keyboard, a mouse, a touchscreen, a microphone for receiving audible commands, and a camera for capturing images and videos to be uploaded to the communication module.

25. The system of claim 23, wherein the user device memory further includes a browser application or a dedicated application that facilitates the communication between the user device and the communication module over the wide area network.

26. The system of claim 23, wherein the user device is selected from a group consisting of a desktop computer, a laptop computer, a tablet, a smartphone, and a wearable device.

27. The system of claim 22, wherein the production module is in communication with a combination of a printer and a cutter integrated within a single machine, the single machine configured to both print the image on an outer surface of the product blank based on the image file, and to cut a shape out of the product blank based on the die-line file.

28. The system of claim 22, further comprising:
a high-resolution scanner integrated with the production module, configured to capture detailed images of the customized printed product for post-manufacture for quality control purposes,
wherein the processor of the system server is configured to compare captured images with the image file using a machine learning model to ensure that the customized printed product adheres to predetermined quality standards before dispatch.

29. The system of claim 21, further comprising:
a graphical processing unit (GPU) or a central processing unit (CPU) within the system server, configured to accelerate a processing of complex image analysis and machine learning tasks related to manufacture the customized printed product,
wherein the GPU or the CPU is utilized by the communication module to enable rapid generation and real-time rendering of the preview of the die-line file and the image file, enhancing user experience by providing immediate visual feedback on customization choices.

30. A computer-implemented method for manufacturing a customized printed product, the method comprising steps of:
providing a system server equipped with a processor and a memory, wherein the memory stores a plurality of modules including a communication module and an apportionment module;
utilizing artificial intelligence, by the apportionment module, to analyze an image uploaded by a user and automatically generate a plurality of available crop types based on content of the image;
providing, by the communication module, previews of each available crop type to the user;
enabling the user to perform a manual selection of a selected crop type from the plurality of available crop types; and
generating, by the apportionment module, a die-line file and an image file based on the selected crop type for production of the customized printed product.

31. A system for manufacturing a customized printed product, comprising:
a system server having a processor and a memory on which a plurality of modules including tangible, non-transitory, processor executable instructions are stored, the plurality of modules including
an apportionment module configured to utilize artificial intelligence to analyze an image uploaded by a user and automatically generate a plurality of available crop types based on content of the image; and
a communication module configured to provide the user with previews of each of the plurality of available crop types for manual selection of a selected crop type from the plurality of available crop types for production of the customized printed product.

32. A computer-implemented method for manufacturing a customized printed product, the method comprising steps of:
providing a system server equipped with a processor and a memory, wherein the memory stores a plurality of modules including a communication module and an apportionment module;
receiving, by the communication module, audible or typewritten instructions from a user, including specific commands for creating the customized printed product;
utilizing artificial intelligence, by the apportionment module, to analyze an image in accordance with the audible or typewritten instructions and generate a custom crop type based on the specific commands;
providing, by the communication module, a final product preview for approval by the user; and
upon user approval, generating, by the apportionment module, a die-line file and an image file for production of the customized printed product, wherein the artificial intelligence is configured to automatically apportion or crop the image as indicated by the user in real-time.

33. A system for manufacturing a customized printed product, comprising:
a system server having a processor and a memory on which a plurality of modules including tangible, non-transitory, processor executable instructions are stored, the plurality of modules including
a communication module configured to receive audible or typewritten instructions from a user, including specific commands for creating the customized printed product, and configured to provide a final product preview for approval by the user; and
an apportionment module configured to utilize artificial intelligence to analyze an image in accordance with the audible or typewritten instructions and generate a custom crop type based on the specific commands, and configured to, upon user approval, generate a die-line file and an image file for production of the customized printed product, wherein the artificial intelligence is configured to automatically apportion or crop the image as indicated by the user in real-time.
